(19) United States
(12) Patent Application Publication
(10) Pub. No.: US 2020/0210193 A1
(43) Pub. Date: Jul. 2, 2020

(54) HARDWARE PROFILER TO TRACK INSTRUCTION SEQUENCE INFORMATION INCLUDING A BLACKLISTING MECHANISM AND A WHITELISTING MECHANISM

(71) Applicant: Intel Corporation, Santa Clara, CA (US)

(72) Inventors: Sangeeta BHATTACHARYA, Santa Clara, CA (US); Mark DECHENE, Hillsboro, OR (US); John FAISTL, Hillsboro, OR (US); Jason M. AGRON, San Jose, CA (US); Sebastian WINKEL, Los Altos, CA (US); Rangeen BASU ROY CHOWDHURY, Beaverton, OR (US)

(21) Appl. No.: 16/233,035

(22) Filed: Dec. 26, 2018

(51) Int. Cl. G06F 9/38; G06F 9/48; G06F 9/30

(52) U.S. Cl. CPC G06F 9/3836; G06F 9/3861; G06F 9/30145; G06F 9/4812

(57) ABSTRACT

A processor includes a set of execution units in an out-of-order execution pipeline, and a hardware profiler in the out-of-order execution pipeline coupled to the set of execution units and to profile instructions executed by the set of execution units, the hardware profiler to generate a profiling interrupt, the profiling interrupt to initiate an optimization of a basic block of instructions in response to determining that a whitelist bit is set corresponding to the basic block of instructions, the whitelist bit to identify the basic block of instructions for immediate optimization.

### TECHNICAL FIELD

Embodiments of the invention relate to the field of dynamic optimization of instructions in a processor pipeline; and more specifically, to the use of a hardware profiler to identify frequently executed instruction sequences to optimize.

### BACKGROUND

In modern computer architectures a single instruction set architecture (ISA) is typically implemented in a set of one or more central processing units (CPUs). The CPUs execute programs as a set of instructions that have been compiled where the instructions are supported by the single ISA. The compiler optimizes the set of instructions to efficiently run in the ISA. The CPUs load and execute the instructions during runtime.

During runtime execution, each CPU can process instructions out of order. Out-of-Order execution is a process where the instructions are executed by execution units within the CPU in a different order than the instructions occur in the program. Out-of-order execution could cause some instructions to be scheduled to execute before the inputs of these instructions are available. Thus, the CPUs include scheduling and pipelining logic that enables out-of-order execution to be implemented while minimizing the inefficiency of instruction executions by taking into account the input and output dependencies between instructions in the scheduling of the instructions for out-of-order execution.

### BRIEF DESCRIPTION OF THE DRAWINGS

The invention may best be understood by referring to the following description and accompanying drawings that are used to illustrate embodiments of the invention. In the drawings:

FIG. 1 is a diagram of one embodiment of a processor pipeline and memory in which the hardware profiler operates.

FIG. 2 is a diagram of one example embodiment of a whitelisting mechanism implemented in the hardware profiler and optimizer.

FIG. 3 is a diagram of one example embodiment of a blacklisting mechanism shown in combination with the whitelisting mechanism as implemented by the hardware profiler.

FIGS. 4A-4B are block diagrams illustrating a generic vector friendly instruction format and instruction templates thereof according to embodiments of the invention.

FIG. 4A is a block diagram illustrating a generic vector friendly instruction format and class A instruction templates thereof according to embodiments of the invention.

FIG. 4B is a block diagram illustrating the generic vector friendly instruction format and class B instruction templates thereof according to embodiments of the invention.

FIG. 5A is a block diagram illustrating an exemplary specific vector friendly instruction format according to embodiments of the invention.

FIG. 5B is a block diagram illustrating the fields of the specific vector friendly instruction format 500 that make up the full opcode field 474 according to one embodiment of the invention.

FIG. 5C is a block diagram illustrating the fields of the specific vector friendly instruction format 500 that make up the register index field 444 according to one embodiment of the invention.

FIG. 5D is a block diagram illustrating the fields of the specific vector friendly instruction format 500 that make up the augmentation operation field 450 according to one embodiment of the invention.

FIG. 6 is a block diagram of a register architecture 600 according to one embodiment of the invention.

FIG. 7A is a block diagram illustrating both an exemplary in-order pipeline and an exemplary register renaming, out-of-order issue/execution pipeline according to embodiments of the invention.

FIG. 7B is a block diagram illustrating both an exemplary embodiment of an in-order architecture core and an exemplary register renaming, out-of-order issue/execution architecture core to be included in a processor according to embodiments of the invention.

FIGS. 8A-B illustrate a block diagram of a more specific exemplary in-order core architecture, which core would be one of several logic blocks (including other cores of the same type and/or different types) in a chip.

FIG. 8A is a block diagram of a single processor core, along with its connection to the on-die interconnect network 802 and with its local subset of the Level 2 (L2) cache 804, according to embodiments of the invention.

FIG. 8B is an expanded view of part of the processor core in FIG. 8A according to embodiments of the invention.

FIG. 9 is a block diagram of a processor 900 that may have more than one core, may have an integrated memory controller, and may have integrated graphics according to embodiments of the invention.

FIGS. 10-13 are block diagrams of exemplary computer architectures.

FIG. 10 shown a block diagram of a system in accordance with one embodiment of the present invention.

FIG. 11 is a block diagram of a first more specific exemplary system in accordance with an embodiment of the present invention.

FIG. 12 is a block diagram of a second more specific exemplary system in accordance with an embodiment of the present invention.

FIG. 13 is a block diagram of a SoC in accordance with an embodiment of the present invention.

FIG. 14 is a block diagram contrasting the use of a software instruction converter to convert binary instructions in a source instruction set to binary instructions in a target instruction set according to embodiments of the invention.

### DETAILED DESCRIPTION

The following description describes methods and apparatus for dynamically optimizing instructions at runtime by tracking instruction execution information in a hardware profiler. The hardware profiler supports identification of frequently executed instruction sequences, referred to herein as basic blocks of instructions or “hot regions of code,” that can be optimized. The hardware profiler further includes a blacklisting and whitelisting mechanism to improve the efficiency of a dynamic optimization system. The whitelisting mechanism assists in faster identification of already optimized regions of instructions. The blacklisting mechanism provides a mechanism to identify instruction regions that should not be further analyzed for optimizing. These basic blocks of instructions can be determined by processes within the overall dynamic optimization and profiling mechanisms of a processor or pipeline.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set or one or more physical network interface(s) to establish network connections (to transmit and/or receive code and/or data using propagating signals) with other electronic devices. One or more parts of an embodiment of the invention may be implemented using different combinations of software, firmware, and/or hardware.

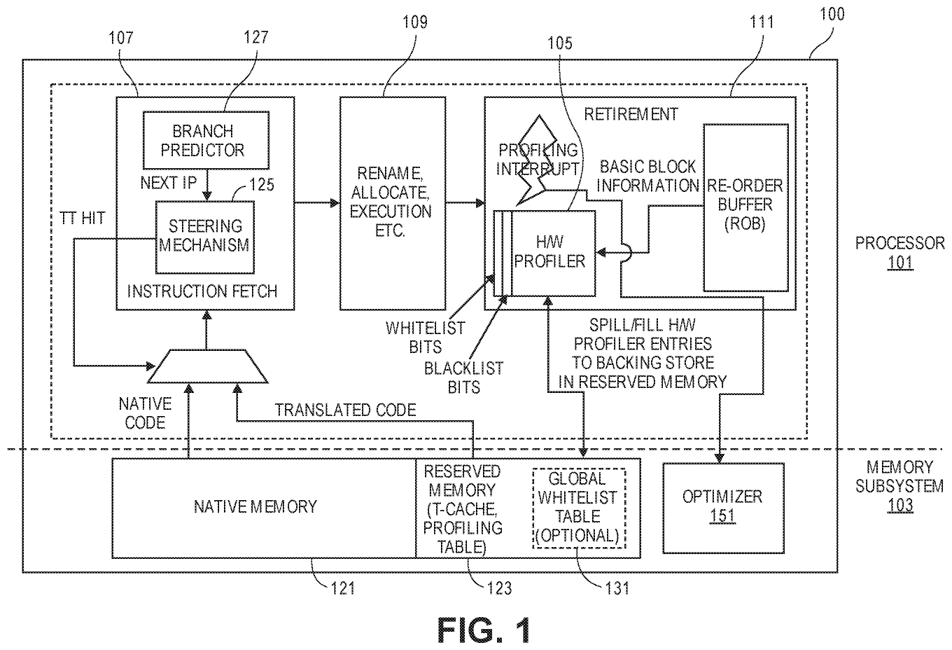

FIG. 1 is a diagram of one embodiment of a processor pipeline and memory in which the hardware profiler operates. The hardware profiler 105 keeps a count of how many times a basic block of instructions is encountered. In some embodiments, each instruction can be tracked, while in other embodiments specific types of instructions such as branches, branch targets, basic blocks, or any combination thereof are tracked. For sake of clarity and conciseness, the embodiments herein discuss the tracking of basic blocks, while one skilled in the art would understand that other sets of instructions can be similarly tracked. In some embodiments, each execution of a basic block is counted. In other embodiments, the count is based on sampling. In the sampling embodiment, the hardware profiler 105 does not examine each basic block. Instead it ‘samples,’ a sub-set of the executed basic blocks where any selection (i.e., sampling) mechanism can be utilized to identify basic blocks to analyze. Once the count exceeds a certain threshold—(i.e., a profiling interrupt threshold) indicating this basic block of instructions is perceived as ‘hot,’ the hardware profiler raises an interrupt (e.g., a profiling interrupt) or similar mechanism to trigger optimization of a set of basic blocks of instructions including hot basic block of instructions, by the optimizer. The optimization of the basic blocks of instructions including the hot basic block of instructions (i.e. a hot region), improves the efficiency of re-executing the hot instruction region in subsequent iterations. The hot basic block identified by the hardware profiler can be a starting point in a set of basic blocks that are analyzed for optimization. In some embodiments, the starting point might not be the hot basic block that triggers a profiling interrupt. Instead, it can be an associated basic block identified by the hardware profiler that is expected to have similar execution count and be the hot region starting point.

The set of blocks considered can by any size or number. For sake of clarity and conciseness, the embodiments discuss optimizing an identified set of basic blocks such as a hot basic block. It should be understood that such optimization is not limited to solely the identified basic block (i.e., the hot basic block). An optimized version of the basic block of instructions is stored and utilized on subsequent occurrences. The basic block of instructions prior to optimization is referred to as native instructions and the execution of such instructions as the pipeline operating in native mode.

In example embodiments, the computing system 101 supports an optimization of the native instructions using a translation process. The translation process is a process where native instructions in a native instruction architecture (ISA) format are translated to another ISA or optimized ISA. As the name indicates, the translation to the optimized ISA also includes an optimization of the translated code. The example embodiments provided herein are primarily described in relation to a computing system 101 where there are native instructions and optimized instructions. In some embodiments with support for translation processes these optimized instructions are in optimized ISA. However, one skilled in the art would understand that the principles, structures, and processes described herein with relation to this example embodiment are also applicable to embodiments without a translation ISA where the native ISA is maintained during optimization and thus the optimized instructions are also in the native ISA.

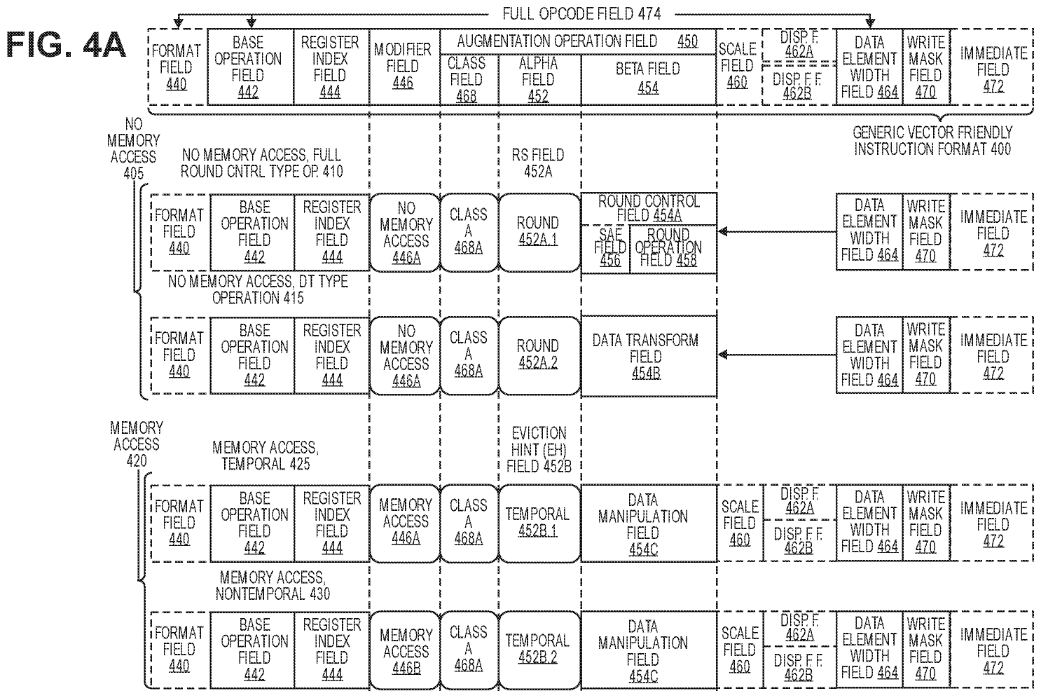

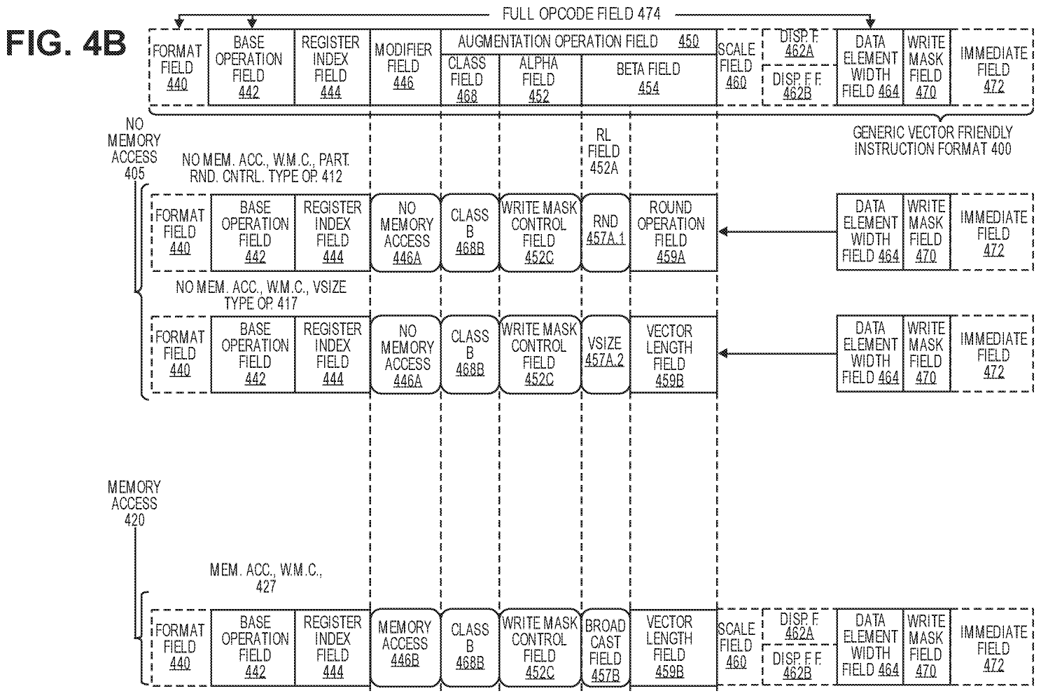

The example computing system 100 has been abstracted to illustrate the components of the computing system 101 that are most relevant to the operation of the hardware profiler 105, optimizer, whitelist mechanism, and blacklist mechanism. One skilled in the art would appreciate that the computing system 100, processor 101, and memory subsystem 103 include additional components. Examples of some of these additional structures are illustrated in FIGS. 4A to 14.

The computing system 100 includes a set of processors 101 and a memory subsystem 103. A portion of a single processor 101 is shown for sake of illustrating the operation of the hardware profile 105. The processor 101 is an out-of-order (OOO) processor with an instruction fetch stage 107, an execution stage 109, and a retirement stage 111. The processor 101 can be a single core or multiple core processor. The hardware profiler 105 can operate on a per core, per processor or similar configuration. The processor 101 is in communication with a memory subsystem 103 that includes a native memory region 121 where native instructions and data are stored and a reserved memory 123 where optimized code (e.g., translated code) and related data are stored.

As mentioned above, the hardware profiler 105 triggers optimization with a profiling interrupt, upon detection of a hot basic block of instructions. A basic block of instructions can have any size or sequence with differing examples of blocks further discussed herein below. The optimization process can be implemented by an optimizer 151. The optimizer can be a translation process that is implemented as software or firmware that is executed in specialized execution units separate from the pipeline (not shown) or in other embodiments the optimization process is implemented within the pipeline. For example, the optimizer 151 can be executed as an interrupt handling routine.

In one example, the optimizer 151 is triggered by the hardware profiler 105 to initiate region formation and translation, i.e. formation and translation of the hot basic blocks of instructions. A count of the number of times that this basic block of instructions has been executed is maintained by the hardware profiler 105. On first identifying the basic block of instructions an entry is created in the hardware profiler with an initial count of 0 which is then incremented on each subsequent execution. When the count exceeds a set threshold, then the profiling interrupt is triggered. At the time the profiling interrupt is triggered, the count for this basic block of instructions can be reset to 0 by the optimizer 151 to prevent the hardware profiler 105 from raising further profiling interrupts for the identified hot basic block.

The hardware profiler 105 can include a per-core, set-associative cache that captures retired instructions (e.g., branch or branch target) profiles. This cache can be referred to as the primary profiling table. The primary profiling table spills to and fills from in memory backing stored in the reserved memory 123 referred to herein as the secondary profiling table. The primary profiling table and the hardware profiler 105, generally, are shared by all threads in a core. The secondary profiling table can be maintained by the optimizer 151 on a per LP basis. Thus, entries in the primary profiling table spill to and fill from the corresponding per LP secondary profiling table. In some embodiments, instruction profiles can include an execution count and in some cases a misprediction count or similar information to guide region formation and translation. In further embodiments a whitelist bit and/or blacklist bit are also maintained. The whitelist bit indicates the possibility of an existing translation code (e.g., containing the branch/target). The blacklist bit indicates that the instructions should not be translated (e.g., a region with a branch/target). The separation between the primary and secondary profiling tables need not be visible to the optimizer 151. Depending on the interface, the optimizer 151 can be aware of just one profiling table. In one embodiment, the optimizer 151 can be given access to just the secondary profiling table with a requirement to first flush the profile data in the primary profiling table to the secondary profiling table. In another embodiment, the optimizer 151 might be given an interface to access the primary profiling table with a mechanism to fetch from the secondary profiling table in case the data is not in the primary profiling table.

In some embodiments, the instruction profiles that are tracked may be related to branch targets and branches and profiles can include execution count, taken count, misprediction count or similar information and any combination thereof to guide region formation and translation. In such embodiments, hot region starting points are likely to be taken branch targets. In some embodiments, the types of branches/targets that are used to trigger profiling interrupts can be limited. For example, where whitelist and blacklist bits are not set then branches that trigger the profiling interrupts can be limited to conditional and backward branches or unconditional branches that are direct near calls, direct near/short jumps with a—backward branch, or similar filters for types of branch/targets.

Region formation is a process of identifying the set of instructions to include in a translation or optimization. Region formation is a cross-block analysis that determines the set of instructions that will be included in the translation. The region formation utilizes profiling data maintained in the hardware profiler to determine the set of blocks to include in the translation. For example, a set of instructions between a branch target and a branch instruction that might span one or more basic blocks. Region formation may also use additional instruction profile data maintained in the hardware profiler to guide region growth like branch bias information, for example. Upon successful region formation and translation, the translated or optimized code is inserted in a translation-cache (T-Cache), which is in the reserved section 123 of the memory subsystem 103. The reserved section 123 is reserved for storing translations/optimizations and associated metadata, and a pointer to the translation, also called the translation entry point, is inserted into a hardware table in the instruction fetch unit 107 called the steering mechanism 125.

The instruction fetch unit 107, a part of the front end of the pipeline of the processor 101, includes a branch predictor 127, the steering mechanism 125 and similar components that enable the fetching of instructions to be scheduled and executed by the pipeline of the processor 101. The branch predictor 107 analyzes branch instructions that are being fetched to determine which path is likely to be taken such that the instructions on that path can also be fetched. The steering mechanism 125 manages a set of functions to decide whether instructions are to be fetched from the native memory 121 or the reserved memory 123. Thus, the steering mechanism 125 is determining whether a translated version of a basic block of instructions to be fetched exists and whether to retrieve the translated version in place of the native version of the basic block of instructions.

The instruction fetch 107 in the pipeline queries or triggers the steering mechanism 125 whenever the instruction fetch 107 encounters a new basic block of instructions in a native version to find an entry point for a translated version corresponding to this basic block that might exist in the reserved memory 123 (e.g., in the T-Cache). If the steering mechanism 125 finds a valid entry point for a basic block of instructions, it ‘steers’ the instruction fetch 107 to retrieve the translated version to be executed by the pipeline of the processor 101. The processor 101 that supports a translation process can execute instructions in a native mode or in a translated mode. If no entry point is found for a translated version, either because it had not yet been created or if otherwise removed from the tracking structure of the steering mechanism, then it is not possible for the instruction fetch 107 to retrieve the translated version of the basic block of instructions and execute it. In this case, the instruction fetch 107 will continue to retrieve and execute the native version of the basic block of instructions instead. Executing the native version means that the processor 101 will not benefit from any of the optimizations in the translated version. The steering mechanism 125 can manage fetching via a multiplexor structure or similar mechanism by driving a selections signal (e.g., tracking table (TT) hit) to determine where instructions are retrieved from (i.e., from memory 121 or reserved memory 123).

A translation entry point can be removed from the tracking table in the steering mechanism 125 for many reasons. One case where a translation entry point is removed from the steering mechanism 125 is where the processor 101 goes to sleep. Another case where the translation entry point is removed is due to an eviction. An eviction occurs due to conflicts in the steering mechanism 125 such as insufficient space in the tracking table of the steering mechanism to store all translation entry points.

Once a translation entry point has been removed from the steering mechanism 125, in order for the translation entry point to be placed back into the steering mechanism 125 and for the pipeline to execute the translated version pointed to by the translation entry point, the hardware profiler 105 needs to observe the corresponding native version of the basic block of instructions again. For example, the profiling interrupt threshold may need to be exceeded again. If the profiling interrupt is triggered for the basic block of instructions, then the optimizer 151 finds the existing translated version by searching its data structures (i.e., a profiling table), and inserts the translation entry point back into the steering mechanism. Once the translation entry point has been re-inserted into the steering mechanism 125, then upon the next invocation of the basic block the steering mechanism will steer the execution to the translated version. This process of the hardware profiler 105 re-recognizing an already translated basic block and replacing the translation entry point into the steering mechanism 125 can take a number of cycles corresponding to the size of the profiling interrupt threshold during which time, the pipeline runs the native version of the basic block of instructions code and does not benefit from the optimized translated version.

To minimize this inefficiency (i.e., to reduce or eliminate the refill of the tracking table in the steering mechanism), the hardware profiler 105 maintains a set of whitelist bits for each tracked basic block of instructions. Utilization of a whitelist requires less overhead and is more accurate in managing the steering mechanism than other alternative solutions such as saving steering mechanism 125 context and contents upon processor 101 sleep, invoking the optimizer 151 to repopulate the steering mechanism 125 on wake from sleep, or analyzing metadata for translated versions in the reserve memory 123.

The hardware profiler 105 can more quickly replace translation entry points in the steering mechanism 125 by adding an extra field in the data tracked related to basic blocks of instructions (i.e., the whitelist bit). The embodiments add the field to the primary profiling table entry (i.e., the tracking structure of the hardware profiler 105 and corresponding secondary profiling table in reserved memory with each entry corresponding to a basic block and including one or more counters) referred to as a whitelist bit. Whenever the hardware profiler 105 observes a basic block of instruction in a native version a check is made in the primary profiling table to determine whether the whitelist bit is set. In this case, if a whitelist bit is set, then the hardware profiler 105 immediately raises a profiling interrupt to trigger the optimizer 151. The optimizer 151 can then search for the corresponding translated version in of the basic block in the reserved memory 123 (i.e., in the T-Cache) and insert the corresponding entry points into the steering mechanism 125. This restores entry points for translated versions of basic blocks faster than alternative solutions with less computational overhead. The embodiments create a fast path for raising the profiling interrupt for basic blocks that are known to be hot and already have a translated version. For other basic blocks, the hardware profiler 105 takes the normal path to raise the interrupt based on the profile interrupt threshold, i.e. after the corresponding counter reaches the profiling interrupt threshold.

The whitelist mechanism is very low cost and complements existing hardware while adding a small amount of logic to manage the whitelist. The whitelist mechanism is a general-purpose mechanism and works well for both steering mechanism 125 flushes due to a processor 101 going to sleep and eviction of entries due to capacity and conflict misses. In one embodiment, a 1-bit whitelist field in every primary profiling table entry and one OR gate to unconditionally raise profiling interrupt when whitelist bit is set for an entry can implement the whitelist mechanism. In some embodiments, additional functions added (e.g., software functions) to the hardware profiler 105 are responsible for setting the whitelist bit in the profiling table. Additional functions can also maintain a global whitelist table 131 and propagate the whitelist information to other cores or processors in the system, thus improving the process or recovering from sleep or steering mechanism management for those cores and processors as well. A global whitelist table 131 can be stored in the reserved memory 123 or similar memory location. This global whitelist table 131 can be a part of or separate from a secondary profiling table maintained by the optimizer 151 in the reserved memory 123.

There are several scenarios that the whitelist mechanism embodiments provide an improved operation for the processor 101. The whitelist mechanism reduces latency of transition to execution of a translated version of basic block, i.e., translation mode operation, upon steering mechanism 125 entry evictions. If a translation entry point was evicted from the steering mechanism 125 (due to collisions, simultaneous multithreading (SMT), context switch or similar cases), the counter for the native version of the basic block needs to count back up to the profiling interrupt threshold before it can raise a profiling interrupt and replace the translation entry point in the steering mechanism 125. Multiple processes can run on the same logical processor (LP). The operating system maps multiple processes to the same LP and context switches between them. This can cause evictions of steering mechanism entries corresponding to the inactive processes. The whitelist mechanism also improves the latency of transition to translated mode on microarchitectural sleep exit (e.g., idle states, such as advance configuration and power interface-C (ACPI-C states) and similar states). This includes various hardware and debug flows that may force any processor or any core into sleep. For these cases, the processor 101 or core always wakes up with the exact same process to LP mapping however, the steering mechanism 125 would have been flushed and translation entry points must be refilled. The whitelist mechanism reduces latency of transition to translated mode on a thread migration. The operating system can move a process from one core or LP to other cores/LPs, where the steering mechanism 125 potentially will not have the translation entry points corresponding to this moved process. Using a global whitelist 131 in particular helps this case. The whitelist mechanism also addresses architectural sleep or power down with operating system involvement. This is a subcase that involves the processor 101 or core going to sleep. For these cases, the core may not wake up with the same process to thread mapping. The operating system may switch out an active thread from an LP, map the idle thread on that LP which would coerce the LP to go to sleep.

In one embodiment, the hardware profiler 105 supports two modes of operation for the whitelist mechanism. These two modes target different scenarios. A first mode, referred to as LP scoped, addresses latency of transition to translation mode of execution caused by steering mechanism 125 entry eviction and latency of transition to translation mode of execution caused by exiting sleep mode in the processor or core. For this LP scoped mode, during translation the translation process sets the whitelist bit in the profiling table of the LP that raised the profiling interrupt. In this embodiment, the whitelist mechanism is managed by the optimizer 151. The second mode, referred to as processor scoped, addresses latency caused by thread migration in addition to entry eviction and exiting sleep. This embodiment has a higher complexity for implementation in the optimizer. This embodiment utilizes the global whitelist table 131 in reserved memory 123 that is shared by all LPs. Fast steering mechanism 125 refill can then be supported using this global whitelist table 131 in least two possible implementations. In the first implementation, the optimizer can slowly propagate the whitelist bit to the primary profiling table of all LPs. False positives in this case should only reset the whitelist bit in the corresponding LP's in-memory table and not the global table. In a second implementation, the hardware profiler 105 fetches this attribute from the global whitelist table 131 when filling profiling data from memory. This embodiment utilizes extra hardware in the hardware profiler 105 to implement the fetch. Also, every hardware profiler 105 fill potentially requires two memory accesses.

Returning to the components of the processor 101 pipeline, the instruction fetch unit 107 schedules fetched instructions to execution units, where renaming, allocation, execution and similar processes are carried out in block 109. After execution the instructions are handled by the retirement unit 111. The retirement unit is a set of components for completing the execution of instructions and ensuring proper order of that execution. These components include a reorder buffer (ROB) and similar components. The hardware profiler 105 can be a part of or one of these components.

The operations in the flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

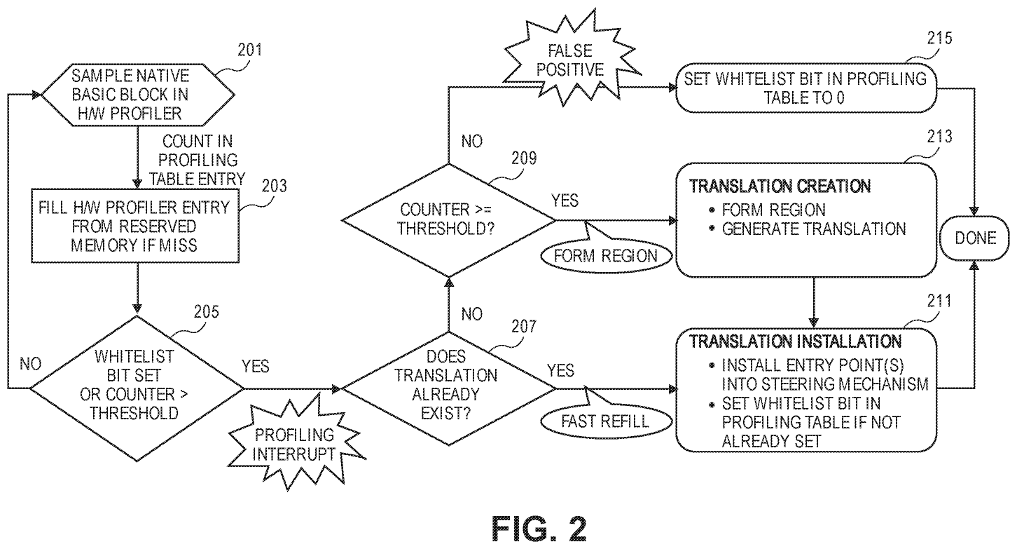

FIG. 2 is a flowchart of one embodiment of the operation of the hardware profiler and optimizer to implement the whitelist mechanism. The example flowchart indicates that in some cases false positives in triggering a profiling interrupt are possible. False positives can occur due to the use of virtual addresses in the hardware profiling and the use of physical addresses in the steering mechanism logic. Also, the primary profiling table is used by all threads whereas, the secondary profiling table is per LP. The optimizer can detect false positives using the fact that a false positive will have the whitelist bit set and a counter value close to 0 but will have no corresponding translations. In such cases, the optimizer clears the whitelist bit and does not form a region (i.e., perform a translation). The embodiments are discussed in relation to profiling utilizing virtual addresses. However, in other embodiments linear, or physical addresses can be utilized in hardware profiling. Thus, the examples of virtual address hardware profiling are provided by way of example and not limitation.

Specifically, as shown in the flowchart of FIG. 2, the whitelist mechanism and the hardware profiling process are triggered each time the hardware profiler identifies or samples a basic block of instructions (Block 201). A basic block of instructions can be any discrete or defined set of sequential instructions such as a block of instructions between a branch target and a next branch instruction. An entry for each basic block is maintained in the primary profiling table in the hardware profiler with each basic block identified by a virtual address of the start of the block and a count indicating a number of executions in native mode. On each native mode execution, the count for the basic block is incremented in the corresponding entry in the primary profiling table. The primary and secondary profiling tables can periodically synchronize, synchronize in response to changes, or similarly update. If there is not an entry for a basic block, then the secondary profiling table maintained by the optimizer in the reserved memory is queried. The secondary profiling table either returns an entry that is inserted into the primary profiling table or the primary profiling table creates an entry for the basic block (Block 203). A check is then made whether the whitelist bit is set for the primary profiling table entry of the basic block or if the counter has exceeded a profiling interrupt threshold (Block 205). If the whitelist bit is not set and the counter is below the profiling interrupt threshold, then the process continues to sample the next basic block (Block 201).

If the whitelist bit is set or the profiling interrupt threshold has been met, then the hardware profiler can call or signal the optimizer to process the basic block using a profiling interrupt. In one embodiment, the interrupt handler can identify the profiling interrupt and start the execution of the optimizer. The optimizer checks whether a translated version of the basic block already exists in a translation index table, or similar tracking structure (Block 207). If a translated version exists in the reserved memory, then the optimizer inserts the translation entry point for the basic block code in the tracking mechanism of the steering mechanism (Block 211). The whitelist bit is also set (if it is not already set). The profiling interrupt is then completed and cleared.

If the translated version does not already exist in the translation index table or similar tracking structure of the optimizer, then the optimizer checks if the basic block execution count is equal to or greater than the threshold in the profiling table (Block 209). If the threshold is exceeded, then the optimizer forms the region (i.e., the set of instructions to be translated) and generates the translation (Block 213). The translated version is stored in the reserved memory and a tracking index of the translated versions is updated. The translation entry point is then added to the steering mechanism and the whitelist bit is set in the profiling table (Block 211). The profiling interrupt process then completes and clears.

If the counter is not equal to or greater than the threshold, then a false positive is detected (Block 215). In this case, the whitelist bit in the profiling table is cleared and the process completes. In cases where the secondary profiling table in the reserve memory is updated by the optimizer, these changes can be propagated to the primary profiling table or tracking information of the hardware profiler.

A context switch between two processes on the same LP is an example case where the whitelist mechanism described herein can be applied and where the whitelist mechanism is able to avoid a false positive. In this example, a process ‘A’ runs on an LP for a while, hot basic blocks of instructions are profiled, regions are formed and translations are created for these hot basic blocks of instructions. The whitelist bit is set in the profiling table during translation insertion. At a subsequent point in time, process A goes to sleep, then process ‘B’ wakes up on the same LP. Process B has cold basic blocks at the same IP as process A, but these will not hit in the steering mechanism since the steering mechanism is physical address (PA) based. These basic blocks executed by process B will however trigger the whitelist mechanism in the hardware profiler as they alias with the whitelisted basic blocks from process A. Thus, the hardware profiler raises a profiling interrupt for a cold basic block of process B. The optimizer will service this interrupt and look up the cold basic blocks in its data structures but will not find a translation corresponding to the cold basic block of process B, since the data structures of the optimizer track blocks by physical addresses and the basic blocks of process A and process B happen only to have the same virtual address (i.e., IP). The optimizer could be configured to handle this case by forming a region for the basic block of process B. However, this would be problematic since the basic block that triggered the profiling interrupt is not yet hot and the interrupt was raised due to whitelist bit being set for a basic block from a different process (i.e., process A). Instead, the optimizer can determine that this interrupt was a false positive by examining the counter value, which will be low for the cold basic block, and the whitelist bit, which should be set for basic block from process A, and then ignore the profiling interrupt. It should also reset the whitelist bit to avoid further interrupts until the basic block becomes hot and raises a true profiling interrupt.

The example can continue where process B goes to sleep. Process A wakes up on the same LP and at least two scenarios can occur. If the steering mechanism entry for the hot translation of process A was evicted by process B's translations, a check for the hot translation will miss in the steering mechanism and hardware profiler will increment the associated basic block counter. A whitelist interrupt will not be raised since the bit was reset as set forth above. This is the worst-case behavior and requires both the virtual address for the hardware profiler whitelist bit to be cleared and the physical address based entry for steering mechanism to be evicted and to alias. This scenario is unlikely. In some embodiments, an address space identifier (ASID) can be used in the hardware profiler's indexing scheme which would reduce the likelihood of this scenario. If the steering mechanism entry survived the context switch, then the hot basic block will hit in the steering mechanism and its translations will continue to be utilized.

False positives can occur where the hardware profiler 105 utilizes virtual addresses to profile branches or basic blocks. In embodiments where the hardware profiler 105 instead uses physical addresses, the process does not encounter this problem of false positives. The whitelist mechanism and blacklist mechanism are compatible with the hardware profiler 105 using either virtual addresses or physical addresses for profiling.

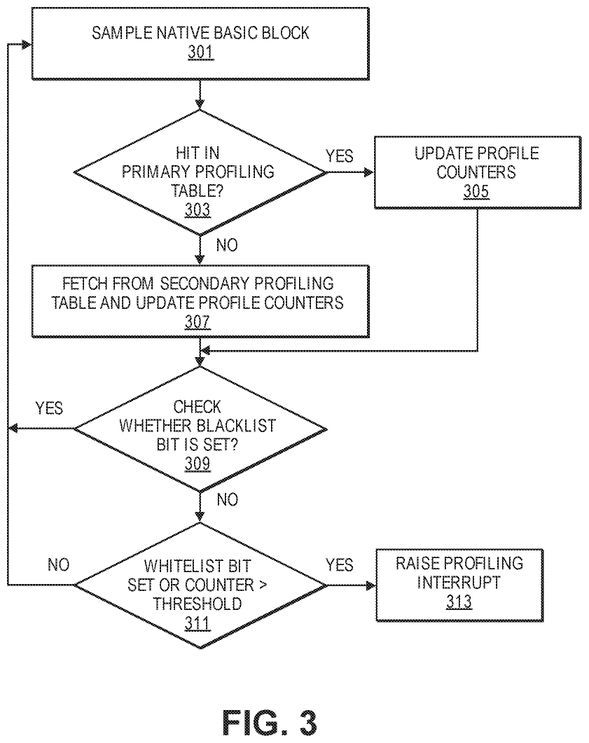

FIG. 3 is a diagram of one example embodiment of a blacklisting mechanism shown in combination with the whitelisting mechanism as implemented by the hardware profiler. The example flowchart shows the operation of the hardware profiler in evaluating when to generate a profiling interrupt.

Specifically, the process shown in the flowchart of FIG. 3 is in combination with the whitelist mechanism described herein above. The hardware profiling process are triggered each time the hardware profiler identifies or samples a basic block of instructions (Block 301). A basic block of instructions can be any discrete or defined set of sequential instructions such as a block of instructions between a branch target and a next branch instruction. An entry for each basic block is maintained in a profiling table in the hardware profiler with each basic block identified by an address (e.g., virtual address or an instruction pointer (IP)) and at least a count indicating the number of executions in native mode. On each (precise or sampled) native mode execution, a check of the primary profiling table is made for a matching profile entry (Block 303). If a match is found, then the count for the basic block is incremented in the corresponding entry in the profiling table (Block 305). If there is not an entry for a basic block in the primary profiling table, then the profiling table in the reserved memory is queried (Block 307). The hardware profiler either retrieves an entry or creates an entry for the basic block and increments the count. A check is then made whether the blacklist bit is set for the profiling table entry of the basic block (Block 309). If the blacklist bit is set, then the process continues to sample the next basic block and ignores the current sampled basic block (Block 301).

If the blacklist bit is not set, then a check is made whether the whitelist bit is set for the profiling table entry of the basic block or if the counter has exceeded a profiling interrupt threshold (Block 311). If the whitelist bit is not set and the counter is below the profiling interrupt threshold, then the process continues to sample the next basic block (Block 301).

If the whitelist bit is set or the profiling interrupt threshold has been met, then the profiling hardware can call or signal the optimizer to process the identified hot basic block using a profiling interrupt (Block 313). The interrupt handler can identify the profiling interrupt and start the execution of the optimizer. The optimizer checks whether a translated version of the basic block already exists in a translation index table or similar tracking structure. The operation of the optimizer can be the same as that described above with regard to the whitelist mechanism.

Additional functions and features can be incorporated into the hardware profiling to improve efficiency of the dynamic optimization system. One skilled in the art would understand that the functions and features described with relation to hardware profiling are provided by way of example and not limitation. For example, the hardware profiling can support the tracking of ‘aging’ where instruction profiles in the primary and secondary profiling tables are aged. The instruction profiles can be zeroed out or reduced (e.g., the value divided by 2 over time). When the aging value reaches zero or a similar threshold then the instruction profile can be discarded. The aging process can be used to avoid translating relatively ‘cold’ regions that might get hot over a longer time period. Other similar functions can be supported by the hardware profiling.

### EXAMPLES

In one example embodiment, a processor includes a set of execution units in an out-of-order execution pipeline, and a hardware profiler in the out-of-order execution pipeline coupled to the set of execution units and to profile instructions executed by the set of execution units, the hardware profiler to generate a profiling interrupt, the profiling interrupt to initiate an optimization of a basic block of instructions in response to determining that a whitelist bit is set corresponding to the basic block of instructions, the whitelist bit to identify the basic block of instructions for immediate optimization.

The processor can include any combination of an optimizer to perform the optimization and insert translation entry points into a steering mechanism of an instruction fetch of the out-of-order execution pipeline and a steering mechanism to determine whether optimized instructions are available and to direct the instruction fetch to retrieve the optimized instructions from a reserved memory, where the optimized instructions have a higher instruction per cycle throughput than native instructions. The optimizer can in some embodiment further detect false positive profiling interrupts. The hardware profiler in some embodiments further maintains a blacklisting bit to identify the basic block of instructions as being blocked from optimization. The hardware profiler can further check a global whitelist data structure in reserved memory. The hardware profiler can further manage an execution count for the basic block of instructions and compare with a profiling threshold to determine when to raise a profiling interrupt.

In another embodiment, a method includes sampling a basic block of instructions, and generating a profiling interrupt to initiate an optimization of the basic block of instructions in response to determining that a whitelist bit is set corresponding to the basic block of instructions, the profiling interrupt to initiate an optimization of the basic block of instructions, the whitelist bit to identify the basic block of instructions for immediate optimization.

The method can further include any one or more of performing the optimization of the basic block of instructions, inserting translation entry points for the optimized basic block of instructions into a steering mechanism of an instruction fetch of an out-of-order execution pipeline, detecting false positive profiling interrupt, determining whether optimized instructions are available, directing the instruction fetch to retrieve the optimized instructions from a reserved memory, maintaining a blacklisting bit to identify the basic block of instructions as being blocked from optimization, checking a global whitelist table in reserved memory, managing an execution count for the basic block of instructions, and comparing the execution count with a profiling threshold to determine when to raise the profiling interrupt.

In one embodiment, a computing system includes a memory subsystem including a memory for native instructions and a reserve memory for optimized instructions, and a processor with at least one core having an out-of-order execution pipeline, the out-of-order pipeline including, a hardware profiler to generate a profiling interrupt to initiate an optimization of a basic block of instructions in response to determining that a whitelist bit is set corresponding to the basic block of instructions, the profiling interrupt to initiate an optimization of a basic block of instructions in response to determining that a whitelist bit is set corresponding to the basic block of instructions, the whitelist bit to identify the basic block of instructions for immediate optimization.

The computing system can further include any one or more of an optimizer to perform the optimization and to insert translation entry points into a steering mechanism of an instruction fetch of the out-of-order execution pipeline, where, for example, the optimizer is further to detect false positive profiling interrupts, and a steering mechanism to determine whether optimized instructions are available and to direct the instruction fetch to retrieve the optimized instructions from a reserved memory. The hardware profiler maintains a blacklisting bit to identify the basic block of instructions as being blocked from optimization. The hardware profiler checks a global whitelist table in reserved memory.

An instruction set may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down though the definition of instruction templates (or subformats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an exemplary ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. A set of SIMD extensions referred to as the Advanced Vector Extensions (AVX) (AVX1 and AVX2) and using the Vector Extensions (VEX) coding scheme has been released and/or published (e.g., see Intel® 64 and IA-32 Architectures Software Developer's Manual, September 2014; and see Intel® Advanced Vector Extensions Programming Reference, October 2014).

Embodiments of the instruction(s) described herein may be embodied in different formats. Additionally, exemplary systems, architectures, and pipelines are detailed below. Embodiments of the instruction(s) may be executed on such systems, architectures, and pipelines, but are not limited to those detailed.

A vector friendly instruction format is an instruction format that is suited for vector instructions (e.g., there are certain fields specific to vector operations). While embodiments are described in which both vector and scalar operations are supported through the vector friendly instruction format, alternative embodiments use only vector operations the vector friendly instruction format.

FIGS. 4A-4B are block diagrams illustrating a generic vector friendly instruction format and instruction templates thereof according to embodiments of the invention. FIG. 4A is a block diagram illustrating a generic vector friendly instruction format and class A instruction templates thereof according to embodiments of the invention; while FIG. 4B is a block diagram illustrating the generic vector friendly instruction format and class B instruction templates thereof according to embodiments of the invention. Specifically, a generic vector friendly instruction format 400 for which are defined class A and class B instruction templates, both of which include no memory access 405 instruction templates and memory access 420 instruction templates. The term generic in the context of the vector friendly instruction format refers to the instruction format not being tied to any specific instruction set.

While embodiments of the invention will be described in which the vector friendly instruction format supports the following: a 64 byte vector operand length (or size) with 32 bit (4 byte) or 64 bit (8 byte) data element widths (or sizes) (and thus, a 64 byte vector consists of either 16 doubleword-size elements or alternatively, 8 quadword-size elements); a 64 byte vector operand length (or size) with 16 bit (2 byte) or 8 bit (1 byte) data element widths (or sizes); a 32 byte vector operand length (or size) with 32 bit (4 byte), 64 bit (8 byte), 16 bit (2 byte), or 8 bit (1 byte) data element widths (or sizes); and a 16 byte vector operand length (or size) with 32 bit (4 byte), 64 bit (8 byte), 16 bit (2 byte), or 8 bit (1 byte) data element widths (or sizes); alternative embodiments may support more, less and/or different vector operand sizes (e.g., 256 byte vector operands) with more, less, or different data element widths (e.g., 128 bit (16 byte) data element widths).

The class A instruction templates in FIG. 4A include: 1) within the no memory access 405 instruction templates there is shown a no memory access, full round control type operation 410 instruction template and a no memory access, data transform type operation 415 instruction template; and 2) within the memory access 420 instruction templates there is shown a memory access, temporal 425 instruction template and a memory access, non-temporal 430 instruction template. The class B instruction templates in FIG. 4B include: 1) within the no memory access 405 instruction templates there is shown a no memory access, write mask control, partial round control type operation 412 instruction template and a no memory access, write mask control, vsize type operation 417 instruction template; and 2) within the memory access 420 instruction templates there is shown a memory access, write mask control 427 instruction template.

The generic vector friendly instruction format 400 includes the following fields listed below in the order illustrated in FIGS. 4A-4B.

Format field 440—a specific value (an instruction format identifier value) in this field uniquely identifies the vector friendly instruction format, and thus occurrences of instructions in the vector friendly instruction format in instruction streams. As such, this field is optional in the sense that it is not needed for an instruction set that has only the generic vector friendly instruction format.

Base operation field 442—its content distinguishes different base operations.

Register index field 444—its content, directly or through address generation, specifies the locations of the source and destination operands, be they in registers or in memory. These include a sufficient number of bits to select N registers from a PxQ (e.g. 32×512, 16×128, 32×1024, 64×1024) register file. While in one embodiment N may be up to three sources and one destination register, alternative embodiments may support more or less sources and destination registers (e.g., may support up to two sources where one of these sources also acts as the destination, may support up to three sources where one of these sources also acts as the destination, may support up to two sources and one destination).

Modifier field 446—its content distinguishes occurrences of instructions in the generic vector instruction format that specify memory access from those that do not; that is, between no memory access 405 instruction templates and memory access 420 instruction templates. Memory access operations read and/or write to the memory hierarchy (in some cases specifying the source and/or destination addresses using values in registers), while non-memory access operations do not (e.g., the source and destinations are registers). While in one embodiment this field also selects between three different ways to perform memory address calculations, alternative embodiments may support more, less, or different ways to perform memory address calculations.

Augmentation operation field 450—its content distinguishes which one of a variety of different operations to be performed in addition to the base operation. This field is context specific. In one embodiment of the invention, this field is divided into a class field 468, an alpha field 452, and a beta field 454. The augmentation operation field 450 allows common groups of operations to be performed in a single instruction rather than 2, 3, or 4 instructions.

Scale field 460—its content allows for the scaling of the index field's content for memory address generation (e.g., for address generation that uses 2^{scale}*index+base).

Displacement Field 462A—its content is used as part of memory address generation (e.g., for address generation that uses 2^{scale}*index+base+displacement).

Displacement Factor Field 462B (note that the juxtaposition of displacement field 462A directly over displacement factor field 462B indicates one or the other is used)—its content is used as part of address generation; it specifies a displacement factor that is to be scaled by the size of a memory access (N)—where N is the number of bytes in the memory access (e.g., for address generation that uses 2^{scale}*index+base+scaled displacement). Redundant low-order bits are ignored and hence, the displacement factor field's content is multiplied by the memory operands total size (N) in order to generate the final displacement to be used in calculating an effective address. The value of N is determined by the processor hardware at runtime based on the full opcode field 474 (described later herein) and the data manipulation field 454C. The displacement field 462A and the displacement factor field 462B are optional in the sense that they are not used for the no memory access 405 instruction templates and/or different embodiments may implement only one or none of the two.

Data element width field 464—its content distinguishes which one of a number of data element widths is to be used (in some embodiments for all instructions; in other embodiments for only some of the instructions). This field is optional in the sense that it is not needed if only one data element width is supported and/or data element widths are supported using some aspect of the opcodes.

Write mask field 470—its content controls, on a per data element position basis, whether that data element position in the destination vector operand reflects the result of the base operation and augmentation operation. Class A instruction templates support merging-writemasking, while class B instruction templates support both merging- and zeroing-writemasking. When merging, vector masks allow any set of elements in the destination to be protected from updates during the execution of any operation (specified by the base operation and the augmentation operation); in other one embodiment, preserving the old value of each element of the destination where the corresponding mask bit has a 0. In contrast, when zeroing vector masks allow any set of elements in the destination to be zeroed during the execution of any operation (specified by the base operation and the augmentation operation); in one embodiment, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the write mask field 470 allows for partial vector operations, including loads, stores, arithmetic, logical, etc. While embodiments of the invention are described in which the write mask field's 470 content selects one of a number of write mask registers that contains the write mask to be used (and thus the write mask field's 470 content indirectly identifies that masking to be performed), alternative embodiments instead or additional allow the mask write field's 470 content to directly specify the masking to be performed.

Immediate field 472—its content allows for the specification of an immediate. This field is optional in the sense that is it not present in an implementation of the generic vector friendly format that does not support immediate and it is not present in instructions that do not use an immediate.

Class field 468—its content distinguishes between different classes of instructions. With reference to FIGS. 4A-B, the contents of this field select between class A and class B instructions. In FIGS. 4A-B, rounded corner squares are used to indicate a specific value is present in a field (e.g., class A 468A and class B 468B for the class field 468 respectively in FIGS. 4A-B).

In the case of the non-memory access 405 instruction templates of class A, the alpha field 452 is interpreted as an RS field 452A, whose content distinguishes which one of the different augmentation operation types are to be performed (e.g., round 452A.1 and data transform 452A.2 are respectively specified for the no memory access, round type operation 410 and the no memory access, data transform type operation 415 instruction templates), while the beta field 454 distinguishes which of the operations of the specified type is to be performed. In the no memory access 405 instruction templates, the scale field 460, the displacement field 462A, and the displacement scale filed 462B are not present.

In the no memory access full round control type operation 410 instruction template, the beta field 454 is interpreted as a round control field 454A, whose content(s) provide static rounding. While in the described embodiments of the invention the round control field 454A includes a suppress all floating point exceptions (SAE) field 456 and a round operation control field 458, alternative embodiments may support may encode both these concepts into the same field or only have one or the other of these concepts/fields (e.g., may have only the round operation control field 458).

SAE field 456—its content distinguishes whether or not to disable the exception event reporting; when the SAE field's 456 content indicates suppression is enabled, a given instruction does not report any kind of floating-point exception flag and does not raise any floating point exception handler.

Round operation control field 458—its content distinguishes which one of a group of rounding operations to perform (e.g., Round-up, Round-down, Round-towards-zero and Round-to-nearest). Thus, the round operation control field 458 allows for the changing of the rounding mode on a per instruction basis. In one embodiment of the invention where a processor includes a control register for specifying rounding modes, the round operation control field's 450 content overrides that register value.

In the no memory access data transform type operation 415 instruction template, the beta field 454 is interpreted as a data transform field 454B, whose content distinguishes which one of a number of data transforms is to be performed (e.g., no data transform, swizzle, broadcast).

In the case of a memory access 420 instruction template of class A, the alpha 452 is interpreted as an eviction hint field 452B, whose content distinguishes which one of the eviction hints is to be used (in FIG. 4A, temporal 452B.1 and non-temporal 452B.2 are respectively specified for the memory access, temporal 425 instruction template and the memory access, non-temporal 430 instruction template), while the beta field 454 is interpreted as a data manipulation field 454C, whose content distinguishes which one of a number of data manipulation operations (also known as primitives) is to be performed (e.g., no manipulation; broadcast; up conversion of a source; and down conversion of a destination). The memory access 420 instruction templates include the scale field 460, and optionally the displacement field 462A or the displacement scale field 462B.

Vector memory instructions perform vector loads from and vector stores to memory, with conversion support. As with regular vector instructions, vector memory instructions transfer data from/to memory in a data element-wise fashion, with the elements that are actually transferred is dictated by the contents of the vector mask that is selected as the write mask.

Temporal data is data likely to be reused soon enough to benefit from caching. This is, however, a hint, and different processors may implement it in different ways, including ignoring the hint entirely.

Non-temporal data is data unlikely to be reused soon enough to benefit from caching in the 1st-level cache and should be given priority for eviction. This is, however, a hint, and different processors may implement it in different ways, including ignoring the hint entirely.

In the case of the instruction templates of class B, the alpha field 452 is interpreted as a write mask control (Z) field 452C, whose content distinguishes whether the write masking controlled by the write mask field 470 should be a merging or a zeroing.

In the case of the non-memory access 405 instruction templates of class B, part of the beta field 454 is interpreted as an RL field 457A, whose content distinguishes which one of the different augmentation operation types are to be performed (e.g., round 457A.1 and vector length (VSIZE) 457A.2 are respectively specified for the no memory access, write mask control, partial round control type operation 412 instruction template and the no memory access, write mask control, VSIZE type operation 417 instruction template), while the rest of the beta field 454 distinguishes which of the operations of the specified type is to be performed. In the no memory access 405 instruction templates, the scale field 460, the displacement field 462A, and the displacement scale filed 462B are not present.

In the no memory access, write mask control, partial round control type operation 410 instruction template, the rest of the beta field 454 is interpreted as a round operation field 459A and exception event reporting is disabled (a given instruction does not report any kind of floating-point exception flag and does not raise any floating point exception handler).

Round operation control field 459A—just as round operation control field 458, its content distinguishes which one of a group of rounding operations to perform (e.g., Round-up, Round-down, Round-towards-zero and Round-to-nearest). Thus, the round operation control field 459A allows for the changing of the rounding mode on a per instruction basis. In one embodiment of the invention where a processor includes a control register for specifying rounding modes, the round operation control field's 450 content overrides that register value.

In the no memory access, write mask control, VSIZE type operation 417 instruction template, the rest of the beta field 454 is interpreted as a vector length field 459B, whose content distinguishes which one of a number of data vector lengths is to be performed on (e.g., 128, 256, or 512 byte).

In the case of a memory access 420 instruction template of class B, part of the beta field 454 is interpreted as a broadcast field 457B, whose content distinguishes whether or not the broadcast type data manipulation operation is to be performed, while the rest of the beta field 454 is interpreted the vector length field 459B. The memory access 420 instruction templates include the scale field 460, and optionally the displacement field 462A or the displacement scale field 462B.

With regard to the generic vector friendly instruction format 400, a full opcode field 474 is shown including the format field 440, the base operation field 442, and the data element width field 464. While one embodiment is shown where the full opcode field 474 includes all of these fields, the full opcode field 474 includes less than all of these fields in embodiments that do not support all of them. The full opcode field 474 provides the operation code (opcode).

The augmentation operation field 450, the data element width field 464, and the write mask field 470 allow these features to be specified on a per instruction basis in the generic vector friendly instruction format.

The combination of write mask field and data element width field create typed instructions in that they allow the mask to be applied based on different data element widths.

The various instruction templates found within class A and class B are beneficial in different situations. In some embodiments of the invention, different processors or different cores within a processor may support only class A, only class B, or both classes. For instance, a high performance general purpose out-of-order core intended for general-purpose computing may support only class B, a core intended primarily for graphics and/or scientific (throughput) computing may support only class A, and a core intended for both may support both (of course, a core that has some mix of templates and instructions from both classes but not all templates and instructions from both classes is within the purview of the invention). Also, a single processor may include multiple cores, all of which support the same class or in which different cores support different class. For instance, in a processor with separate graphics and general purpose cores, one of the graphics cores intended primarily for graphics and/or scientific computing may support only class A, while one or more of the general purpose cores may be high performance general purpose cores with out of order execution and register renaming intended for general-purpose computing that support only class B. Another processor that does not have a separate graphics core, may include one more general purpose in-order or out-of-order cores that support both class A and class B. Of course, features from one class may also be implement in the other class in different embodiments of the invention. Programs written in a high level language would be put (e.g., just in time compiled or statically compiled) into an variety of different executable forms, including: 1) a form having only instructions of the class(es) supported by the target processor for execution; or 2) a form having alternative routines written using different combinations of the instructions of all classes and having control flow code that selects the routines to execute based on the instructions supported by the processor which is currently executing the code.

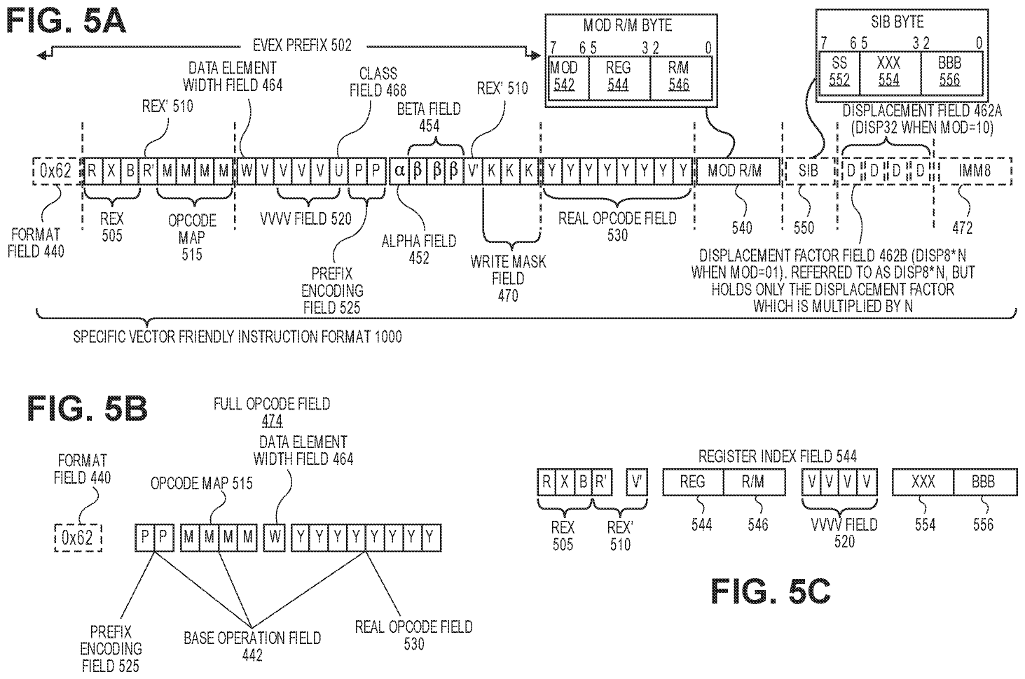

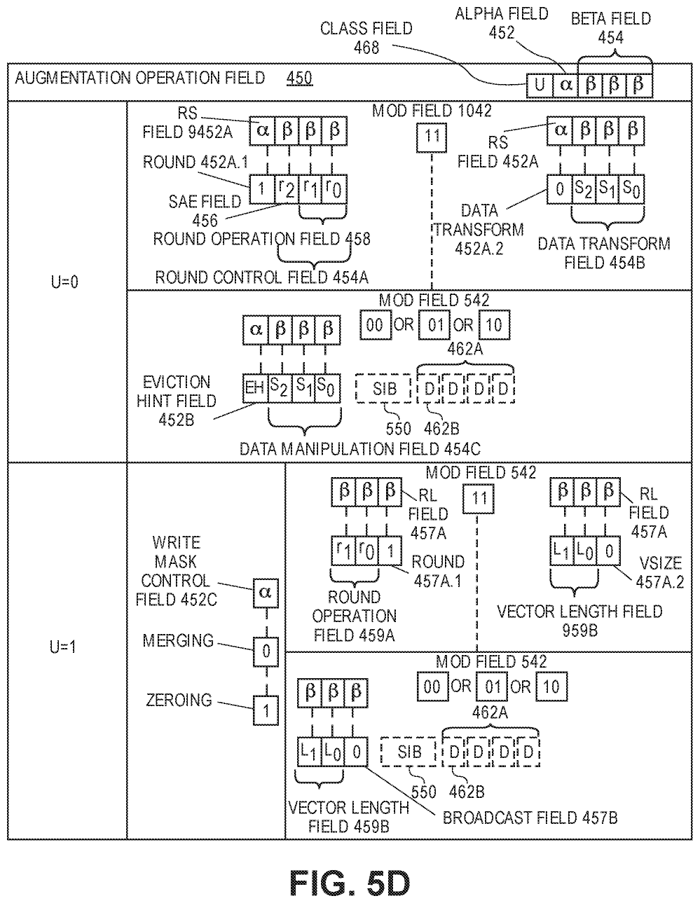

FIG. 5A is a block diagram illustrating an exemplary specific vector friendly instruction format according to embodiments of the invention. FIG. 5A shows a specific vector friendly instruction format 500 that is specific in the sense that it specifies the location, size, interpretation, and order of the fields, as well as values for some of those fields. The specific vector friendly instruction format 500 may be used to extend the x86 instruction set, and thus some of the fields are similar or the same as those used in the existing x86 instruction set and extension thereof (e.g., AVX). This format remains consistent with the prefix encoding field, real opcode byte field, MOD R/M field, SIB field, displacement field, and immediate fields of the existing x86 instruction set with extensions. The fields from FIG. 4 into which the fields from FIG. 5A map are illustrated.

It should be understood that, although embodiments of the invention are described with reference to the specific vector friendly instruction format 500 in the context of the generic vector friendly instruction format 400 for illustrative purposes, the invention is not limited to the specific vector friendly instruction format 500 except where claimed. For example, the generic vector friendly instruction format 400 contemplates a variety of possible sizes for the various fields, while the specific vector friendly instruction format 500 is shown as having fields of specific sizes. By way of specific example, while the data element width field 464 is illustrated as a one bit field in the specific vector friendly instruction format 500, the invention is not so limited (that is, the generic vector friendly instruction format 400 contemplates other sizes of the data element width field 464).

The generic vector friendly instruction format 400 includes the following fields listed below in the order illustrated in FIG. 5A.

EVEX Prefix (Bytes 0-3) 502—is encoded in a four-byte form.

Format Field 440 (EVEX Byte 0, bits [7:0])—the first byte (EVEX Byte 0) is the format field 440 and it contains 0x62 (the unique value used for distinguishing the vector friendly instruction format in one embodiment of the invention).

The second-fourth bytes (EVEX Bytes 1-3) include a number of bit fields providing specific capability.

REX field 505 (EVEX Byte 1, bits [7-5])—consists of a EVEX.R bit field (EVEX Byte 1, bit [7]-R), EVEX.X bit field (EVEX byte 1, bit [6]-X), and 457BEX byte 1, bit[5]-B). The EVEX.R, EVEX.X, and EVEX.B bit fields provide the same functionality as the corresponding VEX bit fields, and are encoded using 1s complement form, i.e. ZMM0 is encoded as 1111B, ZMM15 is encoded as 0000B. Other fields of the instructions encode the lower three bits of the register indexes as is known in the art (rrr, xxx, and bbb), so that Rrrr, Xxxx, and Bbbb may be formed by adding EVEX.R, EVEX.X, and EVEX.B.

REX′ field 410—this is the first part of the REX′ field 410 and is the EVEX.R′ bit field (EVEX Byte 1, bit [4]-R′) that is used to encode either the upper 16 or lower 16 of the extended 32 register set. In one embodiment of the invention, this bit, along with others as indicated below, is stored in bit inverted format to distinguish (in the well-known x86 32-bit mode) from the BOUND instruction, whose real opcode byte is 62, but does not accept in the MOD R/M field (described below) the value of 11 in the MOD field; alternative embodiments of the invention do not store this and the other indicated bits below in the inverted format. A value of 1 is used to encode the lower 16 registers. In other words, R′Rrrr is formed by combining EVEX.R′, EVEX.R, and the other RRR from other fields.

Opcode map field 515 (EVEX byte 1, bits [3:0]-mmmm)—its content encodes an implied leading opcode byte (0F, 0F 38, or 0F 3).

Data element width field 464 (EVEX byte 2, bit [7]-W)—is represented by the notation EVEX.W. EVEX.W is used to define the granularity (size) of the datatype (either 32-bit data elements or 64-bit data elements).

EVEX.vvvv 520 (EVEX Byte 2, bits [6:3]-vvvv)—the role of EVEX.vvvv may include the following: 1) EVEX.vvvv encodes the first source register operand, specified in inverted (1s complement) form and is valid for instructions with 2 or more source operands; 2) EVEX.vvvv encodes the destination register operand, specified in 1s complement form for certain vector shifts; or 3) EVEX.vvvv does not encode any operand, the field is reserved and should contain 1111b. Thus, EVEX.vvvv field 520 encodes the 4 low-order bits of the first source register specifier stored in inverted (1s complement) form. Depending on the instruction, an extra different EVEX bit field is used to extend the specifier size to 32 registers.

EVEX.U 468 Class field (EVEX byte 2, bit [2]-U)—If EVEX.0=0, it indicates class A or EVEX.U0; if EVEX.0=1, it indicates class B or EVEX.U1.

Prefix encoding field 525 (EVEX byte 2, bits [1:0]-pp)—provides additional bits for the base operation field. In addition to providing support for the legacy SSE instructions in the EVEX prefix format, this also has the benefit of compacting the SIMD prefix (rather than requiring a byte to express the SIMD prefix, the EVEX prefix requires only 2 bits). In one embodiment, to support legacy SSE instructions that use a SIMD prefix (66H, F2H, F3H) in both the legacy format and in the EVEX prefix format, these legacy SIMD prefixes are encoded into the SIMD prefix encoding field; and at runtime are expanded into the legacy SIMD prefix prior to being provided to the decoder's PLA (so the PLA can execute both the legacy and EVEX format of these legacy instructions without modification). Although newer instructions could use the EVEX prefix encoding field's content directly as an opcode extension, certain embodiments expand in a similar fashion for consistency but allow for different meanings to be specified by these legacy SIMD prefixes. An alternative embodiment may redesign the PLA to support the 2 bit SIMD prefix encodings, and thus not require the expansion.

Alpha field 452 (EVEX byte 3, bit [7]-EH; also known as EVEX.EH, EVEX.rs, EVEX.RL, EVEX.write mask control, and EVEX.N; also illustrated with α)—as previously described, this field is context specific.

Beta field 454 (EVEX byte 3, bits [6:4]-SSS, also known as EVEX.s₂₋₀, EVEX.r₂₋₀, EVEX.rr1, EVEX.LL0, EVEX.LLB; also illustrated with βββ)—as previously described, this field is context specific.

REX′ field 410—this is the remainder of the REX′ field and is the EVEX.V′ bit field (EVEX Byte 3, bit [3]-V′) that may be used to encode either the upper 16 or lower 16 of the extended 32 register set. This bit is stored in bit inverted format. A value of 1 is used to encode the lower 16 registers. In other words, V′VVVV is formed by combining EVEX.V′, EVEX.vvvv.

Write mask field 470 (EVEX byte 3, bits [2:0]-kkk)—its content specifies the index of a register in the write mask registers as previously described. In one embodiment of the invention, the specific value EVEX.kkk=000 has a special behavior implying no write mask is used for the particular instruction (this may be implemented in a variety of ways including the use of a write mask hardwired to all ones or hardware that bypasses the masking hardware).

Real Opcode Field 530 (Byte 4) is also known as the opcode byte. Part of the opcode is specified in this field.

MOD R/M Field 540 (Byte 5) includes MOD field 542, Reg field 544, and R/M field 546. As previously described, the MOD field's 542 content distinguishes between memory access and non-memory access operations. The role of Reg field 544 can be summarized to two situations: encoding either the destination register operand or a source register operand, or be treated as an opcode extension and not used to encode any instruction operand. The role of R/M field 546 may include the following: encoding the instruction operand that references a memory address, or encoding either the destination register operand or a source register operand.

Scale, Index, Base (SIB) Byte (Byte 6)—As previously described, the scale field's 450 content is used for memory address generation. SIB.xxx 554 and SIB.bbb 556—the contents of these fields have been previously referred to with regard to the register indexes Xxxx and Bbbb.

Displacement field 462A (Bytes 7-10)—when MOD field 542 contains 10, bytes 7-10 are the displacement field 462A, and it works the same as the legacy 32-bit displacement (disp32) and works at byte granularity.

Displacement factor field 462B (Byte 7)—when MOD field 542 contains 01, byte 7 is the displacement factor field 462B. The location of this field is that same as that of the legacy x86 instruction set 8-bit displacement (disp8), which works at byte granularity. Since disp8 is sign extended, it can only address between −128 and 127 bytes offsets; in terms of 64 byte cache lines, disp8 uses 8 bits that can be set to only four really useful values −128, −64, 0, and 64; since a greater range is often needed, disp32 is used; however, disp32 requires 4 bytes. In contrast to disp8 and disp32, the displacement factor field 462B is a reinterpretation of disp8; when using displacement factor field 462B, the actual displacement is determined by the content of the displacement factor field multiplied by the size of the memory operand access (N). This type of displacement is referred to as disp8*N. This reduces the average instruction length (a single byte of used for the displacement but with a much greater range). Such compressed displacement is based on the assumption that the effective displacement is multiple of the granularity of the memory access, and hence, the redundant low-order bits of the address offset do not need to be encoded. In other words, the displacement factor field 462B substitutes the legacy x86 instruction set 8-bit displacement. Thus, the displacement factor field 462B is encoded the same way as an x86 instruction set 8-bit displacement (so no changes in the ModRM/SIB encoding rules) with the only exception that disp8 is overloaded to disp8*N. In other words, there are no changes in the encoding rules or encoding lengths but only in the interpretation of the displacement value by hardware (which needs to scale the displacement by the size of the memory operand to obtain a byte-wise address offset). Immediate field 472 operates as previously described.

FIG. 5B is a block diagram illustrating the fields of the specific vector friendly instruction format 500 that make up the full opcode field 474 according to one embodiment of the invention. Specifically, the full opcode field 474 includes the format field 440, the base operation field 442, and the data element width (W) field 464. The base operation field 442 includes the prefix encoding field 525, the opcode map field 515, and the real opcode field 530.

FIG. 5C is a block diagram illustrating the fields of the specific vector friendly instruction format 500 that make up the register index field 444 according to one embodiment of the invention. Specifically, the register index field 444 includes the REX field 505, the REX′ field 510, the MODR/M.reg field 544, the MODR/M.r/m field 546, the VVVV field 520, xxx field 554, and the bbb field 556.

FIG. 5D is a block diagram illustrating the fields of the specific vector friendly instruction format 500 that make up the augmentation operation field 450 according to one embodiment of the invention. When the class (U) field 468 contains 0, it signifies EVEX.U0 (class A 468A); when it contains 1, it signifies EVEX.U1 (class B 468B). When U=0 and the MOD field 542 contains 11 (signifying a no memory access operation), the alpha field 452 (EVEX byte 3, bit [7]—EH) is interpreted as the rs field 452A. When the rs field 452A contains a 1 (round 452A.1), the beta field 454 (EVEX byte 3, bits [6:4]-SSS) is interpreted as the round control field 454A. The round control field 454A includes a one bit SAE field 456 and a two bit round operation field 458. When the rs field 452A contains a 0 (data transform 452A.2), the beta field 454 (EVEX byte 3, bits [6:4]-SSS) is interpreted as a three bit data transform field 454B. When U=0 and the MOD field 542 contains 00, 01, or 10 (signifying a memory access operation), the alpha field 452 (EVEX byte 3, bit [7]-EH) is interpreted as the eviction hint (EH) field 452B and the beta field 454 (EVEX byte 3, bits [6:4]-SSS) is interpreted as a three bit data manipulation field 454C.

When U=1, the alpha field 452 (EVEX byte 3, bit [7]-EH) is interpreted as the write mask control (Z) field 452C. When U=1 and the MOD field 542 contains 11 (signifying a no memory access operation), part of the beta field 454 (EVEX byte 3, bit [4]-S₀) is interpreted as the RL field 457A; when it contains a 1 (round 457A.1) the rest of the beta field 454 (EVEX byte 3, bit [6-5]-S₂₋₁) is interpreted as the round operation field 459A, while when the RL field 457A contains a 0 (VSIZE 457.A2) the rest of the beta field 454 (EVEX byte 3, bit [6-5]-S₂₋₁) is interpreted as the vector length field 459B (EVEX byte 3, bit [6-5]-L₁₋₀). When U=1 and the MOD field 542 contains 00, 01, or 10 (signifying a memory access operation), the beta field 454 (EVEX byte 3, bits [6:4]-SSS) is interpreted as the vector length field 459B (EVEX byte 3, bit [6-5]-L₁₋₀) and the broadcast field 457B (EVEX byte 3, bit [4]-B).

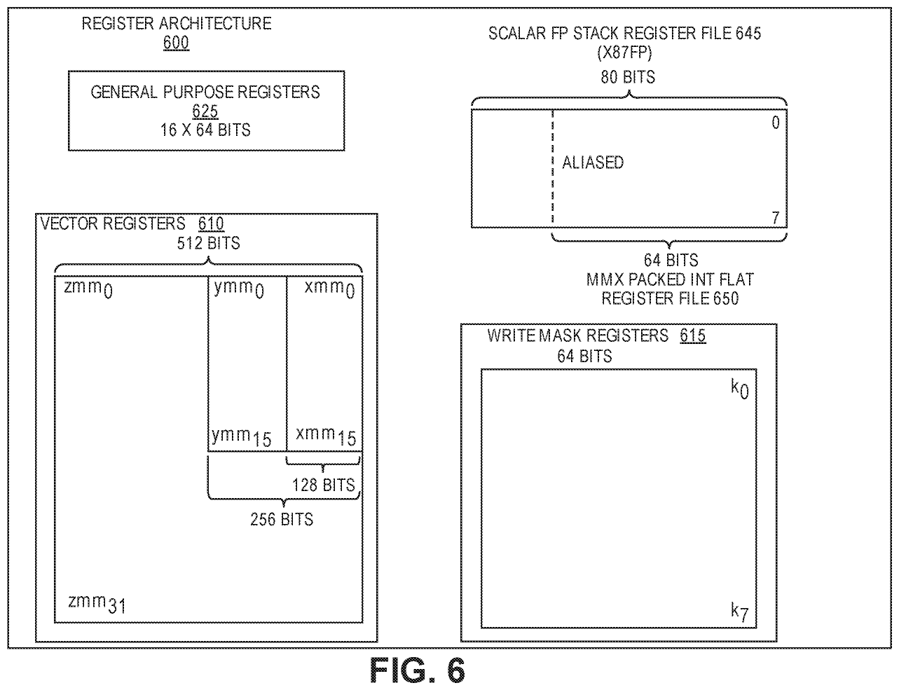

FIG. 6 is a block diagram of a register architecture 600 according to one embodiment of the invention. In the embodiment illustrated, there are 32 vector registers 610 that are 512 bits wide; these registers are referenced as zmm0 through zmm31. The lower order 256 bits of the lower 16 zmm registers are overlaid on registers ymm0-16. The lower order 128 bits of the lower 16 zmm registers (the lower order 128 bits of the ymm registers) are overlaid on registers xmm0-15. The specific vector friendly instruction format 500 operates on these overlaid register file as illustrated in the below tables.

| Adjustable Vector | | | |
|---|---|---|---|
| Length | Class | Operations | Registers |
| Instruction | A (FIG. 4A; | 410, 415, | zmm registers (the |
| Templates that do | U = 0) | 425, 430 | vector length is |
| not include the | | | 64 byte) |
| vector length | B (FIG. 4B; | 412 | zmm registers (the |
| field 459B | U = 1) | | vector length is |
| | | | 64 byte) |
| Instruction templates | B (FIG. 4B; | 417, 427 | zmm, ymm, or xmm |
| that do include the | U = 1) | | registers (the vector |
| vector length field | | | length is 64 byte, |
| 459B | | | 32 byte, or 16 byte) |
| | | | depending on the |
| | | | vector length field |
| | | | 459B |

In other words, the vector length field 459B selects between a maximum length and one or more other shorter lengths, where each such shorter length is half the length of the preceding length; and instructions templates without the vector length field 459B operate on the maximum vector length. Further, in one embodiment, the class B instruction templates of the specific vector friendly instruction format 500 operate on packed or scalar single/double-precision floating point data and packed or scalar integer data. Scalar operations are operations performed on the lowest order data element position in an zmm/ymm/xmm register; the higher order data element positions are either left the same as they were prior to the instruction or zeroed depending on the embodiment.

Write mask registers 615—in the embodiment illustrated, there are 8 write mask registers (k0 through k7), each 64 bits in size. In an alternate embodiment, the write mask registers 615 are 16 bits in size. As previously described, in one embodiment of the invention, the vector mask register k0 cannot be used as a write mask; when the encoding that would normally indicate k0 is used for a write mask, it selects a hardwired write mask of 0xFFFF, effectively disabling write masking for that instruction.

General-purpose registers 625—in the embodiment illustrated, there are sixteen 64-bit general-purpose registers that are used along with the existing x86 addressing modes to address memory operands. These registers are referenced by the names RAX, RBX, RCX, RDX, RBP, RSI, RDI, RSP, and R8 through R15.

Scalar floating point stack register file (x87 stack) 645, on which is aliased the MMX packed integer flat register file 650—in the embodiment illustrated, the x87 stack is an eight-element stack used to perform scalar floating-point operations on 32/64/80-bit floating point data using the x87 instruction set extension; while the MMX registers are used to perform operations on 64-bit packed integer data, as well as to hold operands for some operations performed between the MMX and XMM registers.

Alternative embodiments of the invention may use wider or narrower registers. Additionally, alternative embodiments of the invention may use more, less, or different register files and registers.

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

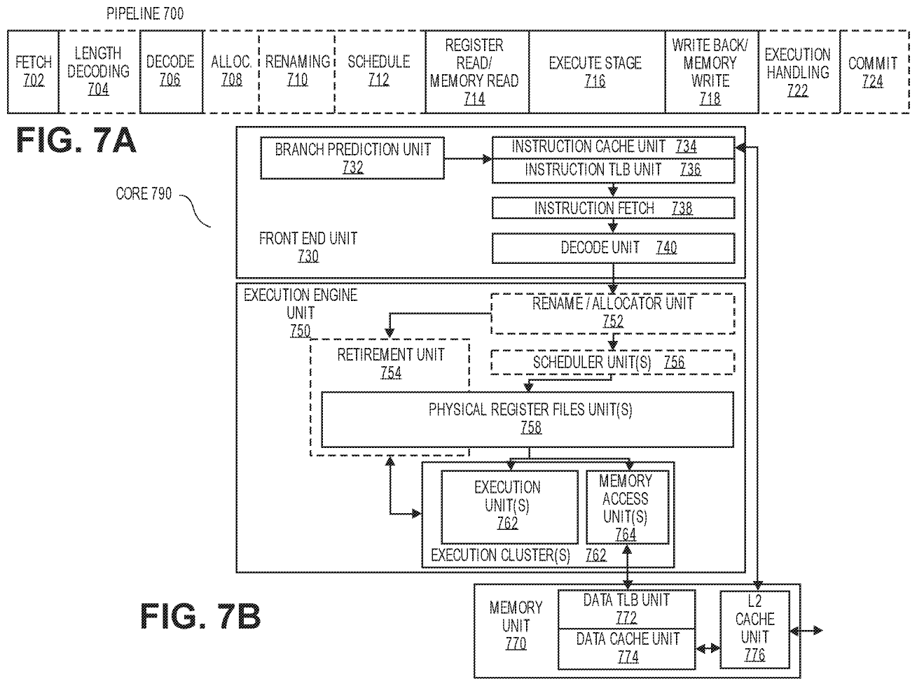

FIG. 7A is a block diagram illustrating both an exemplary in-order pipeline and an exemplary register renaming, out-of-order issue/execution pipeline according to embodiments of the invention. FIG. 7B is a block diagram illustrating both an exemplary embodiment of an in-order architecture core and an exemplary register renaming, out-of-order issue/execution architecture core to be included in a processor according to embodiments of the invention. The solid lined boxes in FIGS. 7A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 7A, a processor pipeline 700 includes a fetch stage 702, a length decode stage 704, a decode stage 706, an allocation stage 708, a renaming stage 710, a scheduling (also known as a dispatch or issue) stage 712, a register read/memory read stage 714, an execute stage 716, a write back/memory write stage 718, an exception handling stage 722, and a commit stage 724.

FIG. 7B shows processor core 790 including a front end unit 730 coupled to an execution engine unit 750, and both are coupled to a memory unit 770. The core 790 may be a reduced instruction set computing (RISC) core, a complex instruction set computing (CISC) core, a very long instruction word (VLIW) core, or a hybrid or alternative core type. As yet another option, the core 790 may be a special-purpose core, such as, for example, a network or communication core, compression engine, coprocessor core, general purpose computing graphics processing unit (GPGPU) core, graphics core, or the like.

The front end unit 730 includes a branch prediction unit 732 coupled to an instruction cache unit 734, which is coupled to an instruction translation lookaside buffer (TLB) 736, which is coupled to an instruction fetch unit 738, which is coupled to a decode unit 740. The decode unit 740 (or decoder) may decode instructions, and generate as an output one or more micro-operations, micro-code entry points, microinstructions, other instructions, or other control signals, which are decoded from, or which otherwise reflect, or are derived from, the original instructions. The decode unit 740 may be implemented using various different mechanisms. Examples of suitable mechanisms include, but are not limited to, look-up tables, hardware implementations, programmable logic arrays (PLAs), microcode read only memories (ROMs), etc. In one embodiment, the core 790 includes a microcode ROM or other medium that stores microcode for certain macroinstructions (e.g., in decode unit 740 or otherwise within the front end unit 730). The decode unit 740 is coupled to a rename/allocator unit 752 in the execution engine unit 750.

The execution engine unit 750 includes the rename/allocator unit 752 coupled to a retirement unit 754 and a set of one or more scheduler unit(s) 756. The scheduler unit(s) 756 represents any number of different schedulers, including reservations stations, central instruction window, etc. The scheduler unit(s) 756 is coupled to the physical register file(s) unit(s) 758. Each of the physical register file(s) units 758 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 758 comprises a vector registers unit, a write mask registers unit, and a scalar registers unit. These register units may provide architectural vector registers, vector mask registers, and general purpose registers. The physical register file(s) unit(s) 758 is overlapped by the retirement unit 754 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 754 and the physical register file(s) unit(s) 758 are coupled to the execution cluster(s) 760. The execution cluster(s) 760 includes a set of one or more execution units 762 and a set of one or more memory access units 764. The execution units 762 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 756, physical register file(s) unit(s) 758, and execution cluster(s) 760 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 764). It should also be understood that where separate pipelines are used, one or more of these pipelines may be out-of-order issue/execution and the rest in-order.

The set of memory access units 764 is coupled to the memory unit 770, which includes a data TLB unit 772 coupled to a data cache unit 774 coupled to a level 2 (L2) cache unit 776. In one exemplary embodiment, the memory access units 764 may include a load unit, a store address unit, and a store data unit, each of which is coupled to the data TLB unit 772 in the memory unit 770. The instruction cache unit 734 is further coupled to a level 2 (L2) cache unit 776 in the memory unit 770. The L2 cache unit 776 is coupled to one or more other levels of cache and eventually to a main memory.

By way of example, the exemplary register renaming, out-of-order issue/execution core architecture may implement the pipeline 700 as follows: 1) the instruction fetch 738 performs the fetch and length decoding stages 702 and 704; 2) the decode unit 740 performs the decode stage 706; 3) the rename/allocator unit 752 performs the allocation stage 708 and renaming stage 710; 4) the scheduler unit(s) 756 performs the schedule stage 712; 5) the physical register file(s) unit(s) 758 and the memory unit 770 perform the register read/memory read stage 714; the execution cluster 760 perform the execute stage 716; 6) the memory unit 770 and the physical register file(s) unit(s) 758 perform the write back/memory write stage 718; 7) various units may be involved in the exception handling stage 722; and 8) the retirement unit 754 and the physical register file(s) unit(s) 758 perform the commit stage 724.

The core 790 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 790 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 734/774 and a shared L2 cache unit 776, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

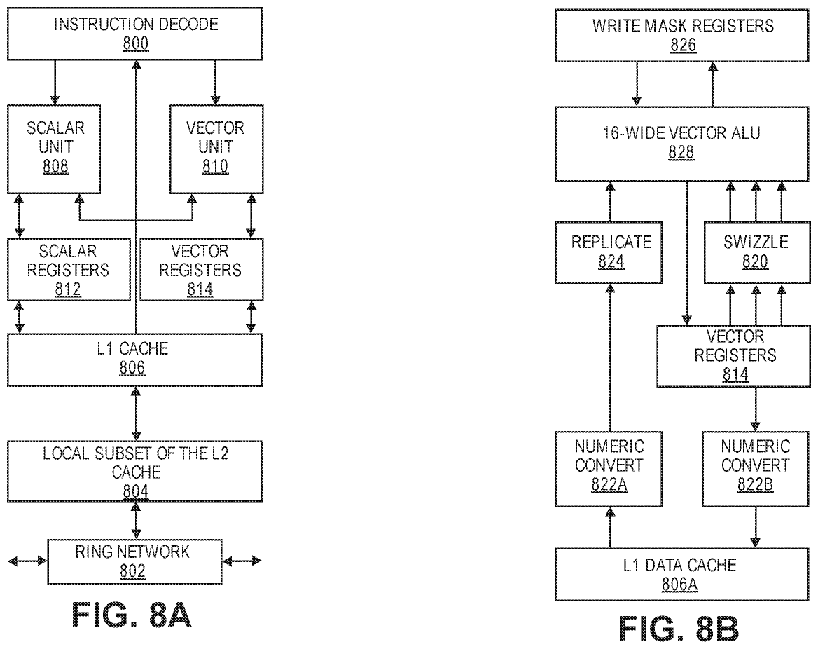

FIGS. 8A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 8A is a block diagram of a single processor core, along with its connection to the on-die interconnect network 802 and with its local subset of the Level 2 (L2) cache 804, according to embodiments of the invention. In one embodiment, an instruction decoder 800 supports the x86 instruction set with a packed data instruction set extension. An L1 cache 806 allows low-latency accesses to cache memory into the scalar and vector units. While in one embodiment (to simplify the design), a scalar unit 808 and a vector unit 810 use separate register sets (respectively, scalar registers 812 and vector registers 814) and data transferred between them is written to memory and then read back in from a level 1 (L1) cache 806, alternative embodiments of the invention may use a different approach (e.g., use a single register set or include a communication path that allow data to be transferred between the two register files without being written and read back).

The local subset of the L2 cache 804 is part of a global L2 cache that is divided into separate local subsets, one per processor core. Each processor core has a direct access path to its own local subset of the L2 cache 804. Data read by a processor core is stored in its L2 cache subset 804 and can be accessed quickly, in parallel with other processor cores accessing their own local L2 cache subsets. Data written by a processor core is stored in its own L2 cache subset 804 and is flushed from other subsets, if necessary. The ring network ensures coherency for shared data. The ring network is bi-directional to allow agents such as processor cores, L2 caches and other logic blocks to communicate with each other within the chip. Each ring data-path is 1012-bits wide per direction.

FIG. 8B is an expanded view of part of the processor core in FIG. 8A according to embodiments of the invention. FIG. 8B includes an L1 data cache 806A part of the L1 cache 804, as well as more detail regarding the vector unit 810 and the vector registers 814. Specifically, the vector unit 810 is a 16-wide vector processing unit (VPU) (see the 16-wide ALU 828), which executes one or more of integer, single-precision float, and double-precision float instructions. The VPU supports swizzling the register inputs with swizzle unit 820, numeric conversion with numeric convert units 822A-B, and replication with replication unit 824 on the memory input. Write mask registers 826 allow predicating resulting vector writes.

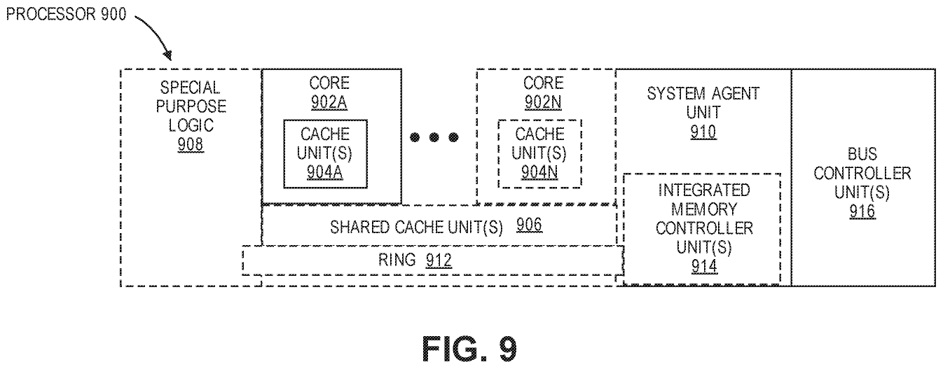

FIG. 9 is a block diagram of a processor 900 that may have more than one core, may have an integrated memory controller, and may have integrated graphics according to embodiments of the invention. The solid lined boxes in FIG. 9 illustrate a processor 900 with a single core 902A, a system agent 910, a set of one or more bus controller units 916, while the optional addition of the dashed lined boxes illustrates an alternative processor 900 with multiple cores 902A-N, a set of one or more integrated memory controller unit(s) 914 in the system agent unit 910, and special purpose logic 908.

Thus, different implementations of the processor 900 may include: 1) a CPU with the special purpose logic 908 being integrated graphics and/or scientific (throughput) logic (which may include one or more cores), and the cores 902A-N being one or more general purpose cores (e.g., general purpose in-order cores, general purpose out-of-order cores, a combination of the two); 2) a coprocessor with the cores 902A-N being a large number of special purpose cores intended primarily for graphics and/or scientific (throughput); and 3) a coprocessor with the cores 902A-N being a large number of general purpose in-order cores. Thus, the processor 900 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 900 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 906, and external memory (not shown) coupled to the set of integrated memory controller units 914. The set of shared cache units 906 may include one or more mid-level caches, such as level 2 (L2), level 3 (L3), level 4 (L4), or other levels of cache, a last level cache (LLC), and/or combinations thereof. While in one embodiment a ring based interconnect unit 912 interconnects the integrated graphics logic 908 (integrated graphics logic 908 is an example of and is also referred to herein as special purpose logic), the set of shared cache units 906, and the system agent unit 910/integrated memory controller unit(s) 914, alternative embodiments may use any number of well-known techniques for interconnecting such units. In one embodiment, coherency is maintained between one or more cache units 906 and cores 902-A-N.

In some embodiments, one or more of the cores 902A-N are capable of multi-threading. The system agent 910 includes those components coordinating and operating cores 902A-N. The system agent unit 910 may include for example a power control unit (PCU) and a display unit. The PCU may be or include logic and components needed for regulating the power state of the cores 902A-N and the integrated graphics logic 908. The display unit is for driving one or more externally connected displays.

The cores 902A-N may be homogenous or heterogeneous in terms of architecture instruction set; that is, two or more of the cores 902A-N may be capable of execution the same instruction set, while others may be capable of executing only a subset of that instruction set or a different instruction set.

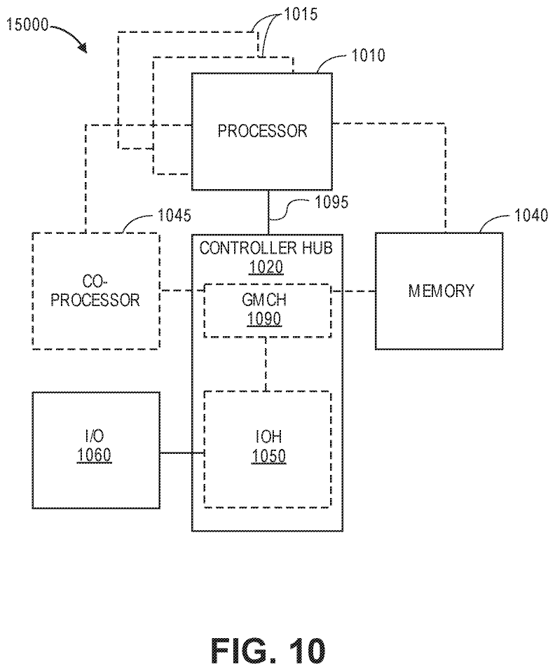

FIGS. 10-13 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 10, shown is a block diagram of a system 1000 in accordance with one embodiment of the present invention. The system 1000 may include one or more processors 1010, 1015, which are coupled to a controller hub 1020. In one embodiment the controller hub 1020 includes a graphics memory controller hub (GMCH) 1090 and an Input/Output Hub (IOH) 1050 (which may be on separate chips); the GMCH 1090 includes memory and graphics controllers to which are coupled memory 1040 and a coprocessor 1045; the IOH 1050 couples input/output (I/O) devices 1060 to the GMCH 1090. Alternatively, one or both of the memory and graphics controllers are integrated within the processor (as described herein), the memory 1040 and the coprocessor 1045 are coupled directly to the processor 1010, and the controller hub 1020 in a single chip with the IOH 1050.

The optional nature of additional processors 1015 is denoted in FIG. 10 with broken lines. Each processor 1010, 1015 may include one or more of the processing cores described herein and may be some version of the processor 900.

The memory 1040 may be, for example, dynamic random access memory (DRAM), phase change memory (PCM), or a combination of the two. For at least one embodiment, the controller hub 1020 communicates with the processor(s) 1010, 1015 via a multi-drop bus, such as a frontside bus (FSB), point-to-point interface such as QuickPath Interconnect (QPI), or similar connection 1095.

In one embodiment, the coprocessor 1045 is a special-purpose processor, such as, for example, a high-throughput MIC processor, a network or communication processor, compression engine, graphics processor, GPGPU, embedded processor, or the like. In one embodiment, controller hub 1020 may include an integrated graphics accelerator.

There can be a variety of differences between the physical resources 1010, 1015 in terms of a spectrum of metrics of merit including architectural, microarchitectural, thermal, power consumption characteristics, and the like.

In one embodiment, the processor 1010 executes instructions that control data processing operations of a general type. Embedded within the instructions may be coprocessor instructions. The processor 1010 recognizes these coprocessor instructions as being of a type that should be executed by the attached coprocessor 1045. Accordingly, the processor 1010 issues these coprocessor instructions (or control signals representing coprocessor instructions) on a coprocessor bus or other interconnect, to coprocessor 1045. Coprocessor(s) 1045 accept and execute the received coprocessor instructions.

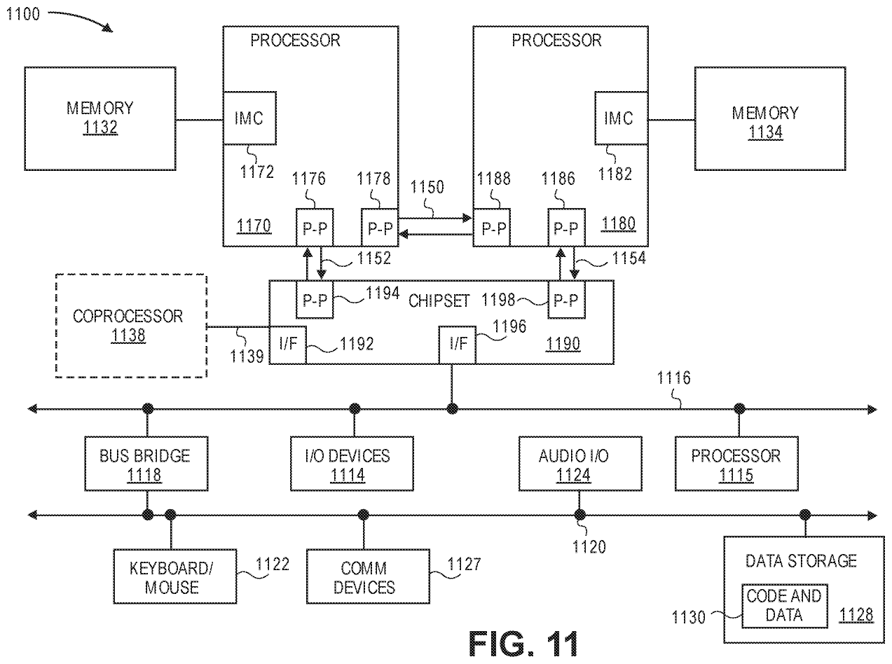

Referring now to FIG. 11, shown is a block diagram of a first more specific exemplary system 1100 in accordance with an embodiment of the present invention. As shown in FIG. 11, multiprocessor system 1100 is a point-to-point interconnect system, and includes a first processor 1170 and a second processor 1180 coupled via a point-to-point interconnect 1150. Each of processors 1170 and 1180 may be some version of the processor 900. In one embodiment of the invention, processors 1170 and 1180 are respectively processors 1010 and 1015, while coprocessor 1138 is coprocessor 1045. In another embodiment, processors 1170 and 1180 are respectively processor 1010 coprocessor 1045.

Processors 1170 and 1180 are shown including integrated memory controller (IMC) units 1172 and 1182, respectively. Processor 1170 also includes as part of its bus controller units point-to-point (P-P) interfaces 1176 and 1178; similarly, second processor 1180 includes P-P interfaces 1186 and 1188. Processors 1170, 1180 may exchange information via a point-to-point (P-P) interface 1150 using P-P interface circuits 1178, 1188. As shown in FIG. 11, IMCs 1172 and 1182 couple the processors to respective memories, namely a memory 1132 and a memory 1134, which may be portions of main memory locally attached to the respective processors.

Processors 1170, 1180 may each exchange information with a chipset 1190 via individual P-P interfaces 1152, 1154 using point to point interface circuits 1176, 1194, 1186, 1198. Chipset 1190 may optionally exchange information with the coprocessor 1138 via a high-performance interface 1192. In one embodiment, the coprocessor 1138 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1190 may be coupled to a first bus 1116 via an interface 1196. In one embodiment, first bus 1116 may be a Peripheral Component Interconnect (PCI) bus, or a bus such as a PCI Express bus or another third generation I/O interconnect bus, although the scope of the present invention is not so limited.

As shown in FIG. 11, various I/O devices 1114 may be coupled to first bus 1116, along with a bus bridge 1118 which couples first bus 1116 to a second bus 1120. In one embodiment, one or more additional processor(s) 1115, such as coprocessors, high-throughput MIC processors, GPGPU's, accelerators (such as, e.g., graphics accelerators or digital signal processing (DSP) units), field programmable gate arrays, or any other processor, are coupled to first bus 1116. In one embodiment, second bus 1120 may be a low pin count (LPC) bus. Various devices may be coupled to a second bus 1120 including, for example, a keyboard and/or mouse 1122, communication devices 1127 and a storage unit 1128 such as a disk drive or other mass storage device which may include instructions/code and data 1130, in one embodiment. Further, an audio I/O 1124 may be coupled to the second bus 1120. Note that other architectures are possible. For example, instead of the point-to-point architecture of FIG. 11, a system may implement a multi-drop bus or other such architecture.

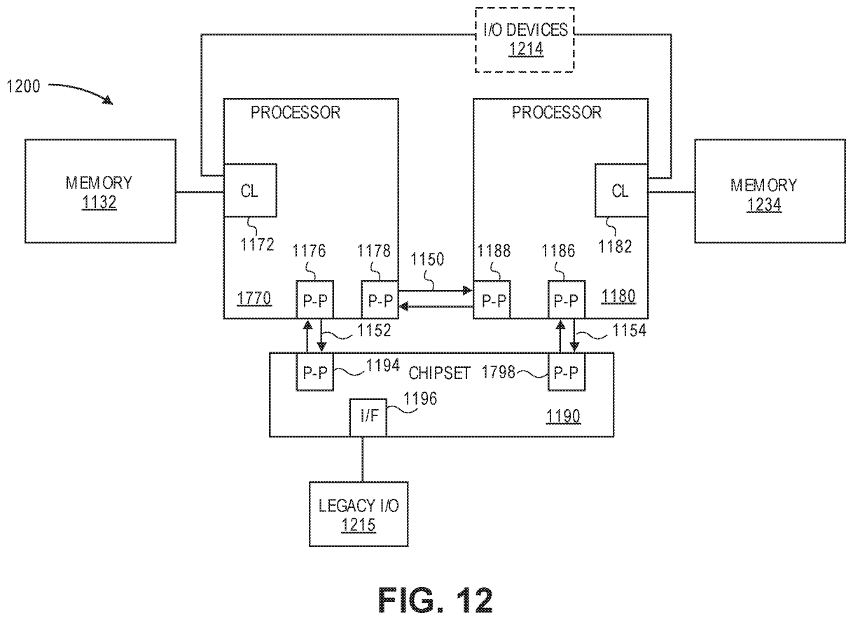

Referring now to FIG. 12, shown is a block diagram of a second more specific exemplary system 1200 in accordance with an embodiment of the present invention. Like elements in FIGS. 11 and 12 bear like reference numerals, and certain aspects of FIG. 11 have been omitted from FIG. 12 in order to avoid obscuring other aspects of FIG. 12.

FIG. 12 illustrates that the processors 1170, 1180 may include integrated memory and I/O control logic (“CL”) 1172 and 1182, respectively. Thus, the CL 1172, 1182 include integrated memory controller units and include I/O control logic. FIG. 12 illustrates that not only are the memories 1132, 1134 coupled to the CL 1172, 1182, but also that I/O devices 1214 are also coupled to the control logic 1172, 1182. Legacy I/O devices 1215 are coupled to the chipset 1190.

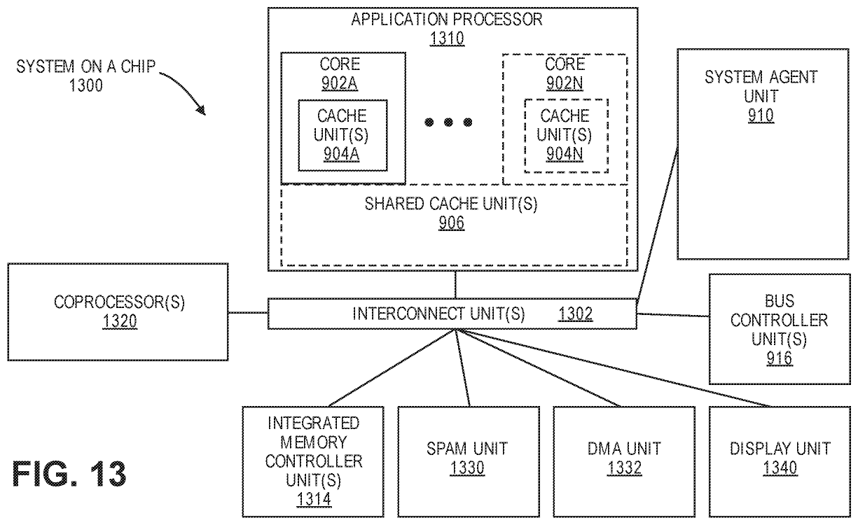

Referring now to FIG. 13, shown is a block diagram of a SoC 1300 in accordance with an embodiment of the present invention. Similar elements in FIG. 9 bear like reference numerals. Also, dashed lined boxes are optional features on more advanced SoCs.

In FIG. 13, an interconnect unit(s) 1302 is coupled to: an application processor 1310 which includes a set of one or more cores 902A-N, which include cache units 904A-N, and shared cache unit(s) 906; a system agent unit 910; a bus controller unit(s) 916; an integrated memory controller unit(s) 914; a set or one or more coprocessors 1320 which may include integrated graphics logic, an image processor, an audio processor, and a video processor; an static random access memory (SRAM) unit 1330; a direct memory access (DMA) unit 1332; and a display unit 1340 for coupling to one or more external displays. In one embodiment, the coprocessor(s) 1320 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 1130 illustrated in FIG. 11, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

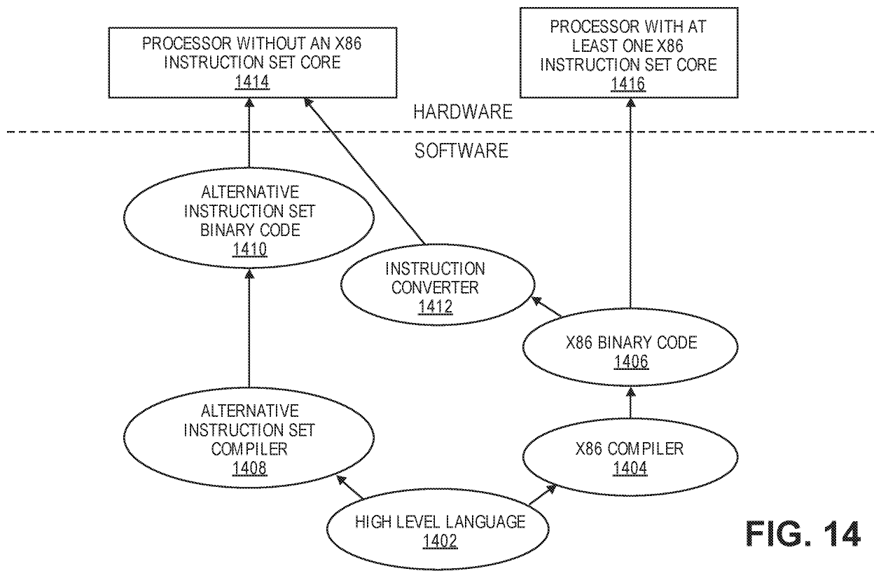

FIG. 14 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 14 shows a program in a high level language 1402 may be compiled using an x86 compiler 1404 to generate x86 binary code 1406 that may be natively executed by a processor with at least one x86 instruction set core 1416. The processor with at least one x86 instruction set core 1416 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1404 represents a compiler that is operable to generate x86 binary code 1406 (e.g., object code) that can, with or without additional linkage processing, be executed on the processor with at least one x86 instruction set core 1416. Similarly, FIG. 14 shows the program in the high level language 1402 may be compiled using an alternative instruction set compiler 1408 to generate alternative instruction set binary code 1410 that may be natively executed by a processor without at least one x86 instruction set core 1414 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1412 is used to convert the x86 binary code 1406 into code that may be natively executed by the processor without an x86 instruction set core 1414. This converted code is not likely to be the same as the alternative instruction set binary code 1410 because an instruction converter capable of this is difficult to make; however, the converted code will accomplish the general operation and be made up of instructions from the alternative instruction set. Thus, the instruction converter 1412 represents software, firmware, hardware, or a combination thereof that, through emulation, simulation or any other process, allows a processor or other electronic device that does not have an x86 instruction set processor or core to execute the x86 binary code 1406.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A processor comprising:
a set of execution units in an out-of-order execution pipeline; and
a hardware profiler in the out-of-order execution pipeline coupled to the set of execution units and to profile instructions executed by the set of execution units, the hardware profiler to generate a profiling interrupt, the profiling interrupt to initiate an optimization of a basic block of instructions in response to determining that a whitelist bit is set corresponding to the basic block of instructions, the whitelist bit to identify the basic block of instructions for immediate optimization.

2. The processor of claim 1, further comprising:
an optimizer to perform the optimization and insert translation entry points into a steering mechanism of an instruction fetch of the out-of-order execution pipeline.

3. The processor of claim 2, wherein the optimizer is further to detect false positive profiling interrupts.

4. The processor of claim 1, further comprising:
a steering mechanism to determine whether optimized instructions are available and to direct an instruction fetch to retrieve the optimized instructions from a reserved memory, where the optimized instructions have a higher instruction per cycle throughput than native instructions.

5. The processor of claim 1, wherein the hardware profiler maintains a blacklisting bit to identify the basic block of instructions as being blocked from optimization.

6. The processor of claim 1, wherein the hardware profiler is to check a global whitelist data structure in reserved memory.

7. The processor of claim 1, wherein the hardware profiler is to manage an execution count for the basic block of instructions and compare with a profiling threshold to determine when to raise a profiling interrupt.

8. A method comprising:
sampling a basic block of instructions; and
generating a profiling interrupt to initiate an optimization of the basic block of instructions in response to determining that a whitelist bit is set corresponding to the basic block of instructions, the profiling interrupt to initiate an optimization of the basic block of instructions, the whitelist bit to identify the basic block of instructions for immediate optimization.

9. The method of claim 8, further comprising:
performing the optimization of the basic block of instructions; and
inserting translation entry points for the optimized basic block of instructions into a steering mechanism of an instruction fetch of an out-of-order execution pipeline.

10. The method of claim 8, further comprising:
detecting false positive profiling interrupts.

11. The method of claim 8, further comprising:
determining whether optimized instructions are available; and
directing an instruction fetch to retrieve the optimized instructions from a reserved memory.

12. The method of claim 8, further comprising:
maintaining a blacklisting bit to identify the basic block of instructions as being blocked from optimization.

13. The method of claim 8, further comprising:
checking a global whitelist table in reserved memory.

14. The method of claim 8, further comprising:
managing an execution count for the basic block of instructions; and
comparing the execution count with a profiling threshold to determine when to raise the profiling interrupt.

15. A computing system comprising:
a memory subsystem including a memory for native instructions and a reserve memory for optimized instructions; and
a processor with at least one core having an out-of-order execution pipeline, the out-of-order pipeline including,
a hardware profiler to generate a profiling interrupt to initiate an optimization of a basic block of instructions in response to determining that a whitelist bit is set corresponding to the basic block of instructions, the profiling interrupt to initiate an optimization of a basic block of instructions in response to determining that a whitelist bit is set corresponding to the basic block of instructions, the whitelist bit to identify the basic block of instructions for immediate optimization.

16. The computing system of claim 15, further comprising:
an optimizer to perform the optimization and to insert translation entry points into a steering mechanism of an instruction fetch of the out-of-order execution pipeline.

17. The computing system of claim 16, wherein the optimizer is further to detect false positive profiling interrupts.

18. The computing system of claim 15, further comprising:
a steering mechanism to determine whether optimized instructions are available and to direct an instruction fetch to retrieve the optimized instructions from a reserved memory.

19. The computing system claim 15, wherein the hardware profiler maintains a blacklisting bit to identify the basic block of instructions as being blocked from optimization.

20. The computing system of claim 15, wherein the hardware profiler checks a global whitelist table in reserved memory.
